(19) United States
(12) Patent Application Publication
(10) Pub. No.: US 2015/0134545 A1
(43) Pub. Date: May 14, 2015

(54) Structure Modelling and Maintenance Scheduling

(71) Applicants: Peter Noel Mann, Stanhope Gardens (AU); John Mathew McGlynn, Springwood (AU)

(72) Inventors: Peter Noel Mann, Stanhope Gardens (AU); John Mathew McGlynn, Springwood (AU)

(73) Assignee: ROADS AND MARITIME SERVICES, North Sydney (AU)

(21) Appl. No.: 14/117,604

(22) PCT Filed: May 11, 2012
(86) PCT No.: PCT/AU2012/000526

§ 371 Date: Nov. 13, 2013

(30) Foreign Application Priority Data
May 13, 2011 (AU) 2011901846

(51) Int. Cl. G06Q 10/00; G06F 17/50

(52) U.S. Cl. CPC G06Q 10/20; G06F 17/5004
USPC 705/305

(57) ABSTRACT

Embodiments of the invention generally relate to computational systems and methods for managing maintenance of a complex structure. A model of the structure is created and stored, which may be a 3D model of the structure including a 3D map, the model defined with reference to components of the complex structure. Maintenance parameters associated with the components are also stored. Examples of possible maintenance parameters include condition rating, criticality rating, access method and cost. Inspection data is input and received by the computational system. A maintenance plan is generated dependent on the maintenance parameters and the inspection data. The model is displayable as part of a 3D map provides a visual representation of information relating to the structure, which may include aspects of the inspection data, the maintenance parameters and the maintenance plan. Embodiments of the invention also relate to a computational system and method for managing maintenance of a painted or coated structure. A paint or coating condition model for at least one element of the structure has a deterioration that progresses as a function of x4, where x is the proportion of the life span of paint or coating that has elapsed. Based on this model a maintenance plan of proposed maintenance is generated and output.

### FIELD OF THE INVENTION

The invention generally relates to the field of computer assisted modelling of structures and to the field of computer assisted scheduling of maintenance activities in relation to a structure.

### BACKGROUND OF THE INVENTION

The maintenance of structures is an ongoing and resource intensive activity. It is therefore necessary to carefully plan and implement maintenance activities. The cost of a deficient maintenance program can be very high, and may result in early replacement of the structure or of expensive component parts of the structure. In addition, a deficient maintenance program may reduce the aesthetic appeal of buildings or iconic structures.

The identification and scheduling of maintenance activities is assisted by the use of computers. Computer systems allow for the storage and retrieval of information regarding a structure and the maintenance performed on that structure, as well as providing tools for prompting maintenance actions. However, current computer systems that the inventors are aware of have limitations and deficiencies, which means that there is substantial room for increased or better use of computer systems to assist with the management of maintenance of a structure.

### SUMMARY OF THE INVENTION

Embodiments of the invention generally relate to computational systems and methods for managing maintenance of a complex structure. A model of the structure is created and stored, which may be a 3D model of the structure including a 3D map, the model defined with reference to components of the complex structure. Maintenance parameters associated with the components are also stored. Examples of possible maintenance parameters include condition rating, criticality rating, access method and cost. Inspection data is input and received by the computational system. A maintenance plan is generated dependent on the maintenance parameters and the inspection data. The model is displayable as part of a 3D map provides a visual representation of information relating to the structure, which may include aspects of the inspection data, the maintenance parameters and the maintenance plan.

In certain embodiments, maintenance priorities are determined with reference to the maintenance parameters and the model may be displayed to visually represent the priority assigned to the maintenance activities.

In certain embodiments, activities are completed via the 3D map. For example, inspection data may be input by displaying the component to be inspected on a display, selecting that component using a suitable user interface, and then entering inspection data for the component in a form that is displayed in response to the selection of that component from the 3D map. In another example, past inspection data for a component may be viewed by selecting the component from the 3D map.

In certain embodiments the model is displayable to visually represent different information. For example, the model is displayable to visually represent the highest priority components for maintenance or the components that would be maintained if a defined amount of resources were spent on maintenance.

Embodiments of the invention relate to a computational system and method for managing maintenance of a painted or coated structure. A paint or coating condition model for at least one element of the structure has a deterioration that progresses as a function of x⁴, where x is the proportion of the life span of paint or coating that has elapsed. Based on this model a maintenance plan of proposed maintenance is generated and output.

Further embodiments of the invention over those described in the preceding paragraphs will become apparent from the following description, given by way of example and with reference to the accompanying drawings.

### BRIEF DESCRIPTION OF THE DRAWINGS

FIG. 1A is a schematic representation of a maintenance system used for maintaining a complex structure.

FIG. 1B shows a segment of the complex structure of FIG. 1A.

FIG. 1C shows a component identification display.

FIG. 2A is a diagrammatic representation of the hardware of the maintenance system shown in FIG. 1.

FIG. 2B is a diagrammatic representation of the software units of the maintenance system of FIG. 1.

FIG. 2C is a main user interface dialog for the software unit of FIG. 2B.

FIG. 2D shows the inspection menu.

FIG. 2E shows the reports menu.

FIG. 2F shows the maintenance menu.

FIG. 2G is an example of a 3D map of the structure.

FIG. 2H is an example of a 3D map used in the maintenance system.

FIG. 3 is a flow diagram of the inspection-maintenance process performed by the maintenance system of FIG. 1A.

FIG. 4A is an entity-relationship model of a database forming part of the maintenance system of FIG. 1.

FIG. 4B shows the paint deterioration rate.

FIG. 4C shows a paint deterioration model.

FIG. 5A shows an inspection report dialog box.

FIG. 5B shows an inspection history panel.

FIG. 6A shows a maintenance schedule dialog box.

FIG. 6B shows a scheduled maintenance form.

FIG. 6C shows a maintenance completed dialog box.

FIG. 6D shows a maintenance history dialog box.

FIG. 6E shows an maintenance report dialog box.

FIG. 6F shows a member report dialog box.

FIG. 6G shows a rating report dialog box.

FIG. 6H shows a rating factor report dialog box.

FIG. 6I shows a rating report spread sheet.

FIG. 6J shows an inspections due form.

FIG. 6K shows an area report spreadsheet.

FIG. 6L shows a predicted condition report dialog box.

FIG. 6M shows a weighting report dialog box.

FIG. 7A shows an archiving dialog box.

FIG. 7B shows an archive retrieval dialog box.

FIG. 8A shows a maintenance type form.

FIG. 8B shows a maintenance treatment dialog box.

FIG. 8C shows a materials form.

FIG. 8D shows an inspection defects form.

FIG. 8E shows another inspection report dialog box.

FIG. 8F shows a further inspection report dialog box.

FIG. 8G shows a help dialog box.

FIG. 8H shows a re-inspection intervals form.

### DETAILED DESCRIPTION OF THE EMBODIMENTS

1. System Overview

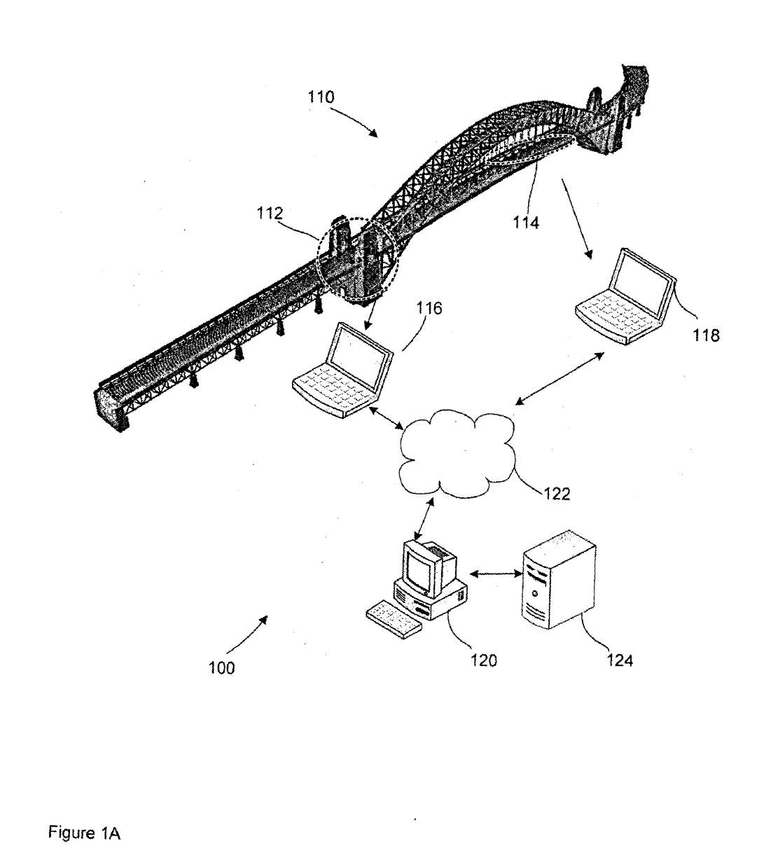

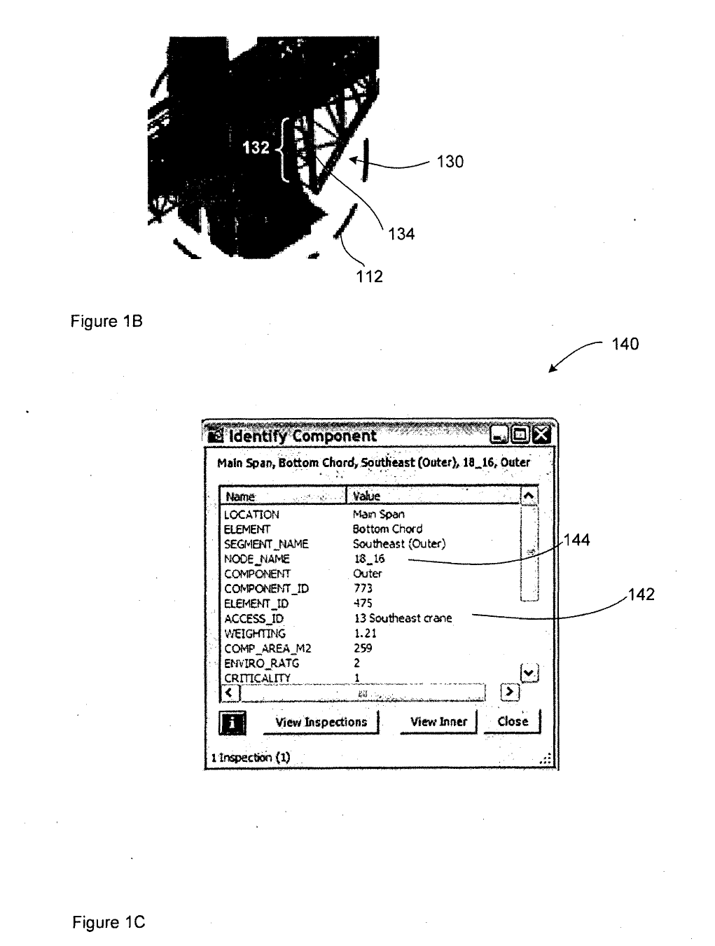

A maintenance system 100 for maintaining a complex structure is shown in FIG. 1A. The structure 110, a bridge in this case (the Sydney Harbour Bridge), consists of a plurality components. In this specification and accompanying claims a ‘component’ refers to the inspection unit for the structure 110 and a group of components is called a ‘segment’. An example of a component is the outer face 132 of the outer southeast segment 130 that forms part of the south pylon 112 of the bridge 110 as shown in FIG. 1B. A component includes one or more elements that require maintenance.

Large structures like bridges may have many thousands of components. Each component is characterised by one or more component features, and the maintenance system 100 maintains a record of the component features associated with each component. These component features are determined for the specific structure. An example of a component feature recorded for the outer face 132 is the way that access is obtained to the component (the access identification, or ACCESS_ID 142): via “13 Southeast crane” as shown in the component identification display 140 in FIG. 1C.

For the embodiment shown in FIG. 1A, component features associated with the components of the bridge 110 also include coating and structural features, and what the cost estimate is for relevant maintenance. Another component feature is the criticality of the component: how critical the condition and maintenance of that specific component is. For the bridge 110 shown in FIG. 1, which is an iconic structure, criticality is determined in part by the visibility of the component to the public. The more visible the component is, the higher the priority is for maintenance on that component.

Each component and each segment typically undergoes an inspection cycle that may take up to, for example, 2 years. The components are maintained as a result of the inspection/s. During the inspection phase a component/segment is inspected to ascertain its condition, resulting in an inspection report and possibly also photographic inspection data.

An element of a component is the maintenance unit. Herein a group of elements is called a ‘node’. For this example, an element associated with the outer face 132 is the bottom chord 134, and the node 144 is called “18_{—}16”. In this embodiment, maintenance relates specifically to the coating and steelwork on the bridge 110, and makes use of a database that includes all of the elements that make up the bridge and which require maintenance relating to the coating or steelwork. A record of the history of each element is maintained, recording details of inspections and maintenance. The recording of this information enables the inspection and maintenance of the structure to be more effectively scheduled. It also aids in planning maintenance access and activity as well as the development of cost estimates.

The maintenance system 100 therefore includes, or has access to, a hierarchical categorisation of parts of the complex structure that requires planning, review, analysis, management and/or recording of maintenance activities. Each part requiring maintenance (an element) is included as part of an inspection unit (a component), which facilitates, for example planning and recording of inspection activities. A component may be one of a plurality of components that form a segment. The segment facilitates higher level inspection related activities. In some embodiments, a component includes a plurality of sub-components, which facilitate lower level inspection related activities.

In addition, each element may be part of a node. A node therefore facilitates, for example planning and recording of maintenance activities. A node may correspond to a segment in the sense of consisting of the same elements. Alternatively, a node may not correspond to a segment, which facilitates independent operations for maintenance activities and inspection activities.

Referring to FIG. 1A, when an inspection of various components of the south pylon 112 is performed, the inspection data is logged using a computer 116. In the same way, inspection data from the main span north deck 114 is logged using another computer 118. The computers 116 and 118 are connected to a main computer 120 via a network 122 such as a digital cellular network, the interne, a proprietary network, an intranet or a combination of these networks. The main computer 120 is connected to a storage device 124 that contains one or more databases relating to the bridge and maintenance of the bridge. The main computer 120 and computers 116, 118 have a master-slave relationship, and synchronise available data: the slaves upload new inspection data to the master, and in turn download updated maintenance and inspection data as required. In an alternative embodiment the inspection data is entered directly into the main computer 120.

In another alternative embodiment, the inspection/maintenance process is not implemented in a master-slave arrangement with a main computer 120 connected to other computers. A single computer is used, and inspection data is entered and accessed directly via that computer's user interface.

2. Computer Hardware

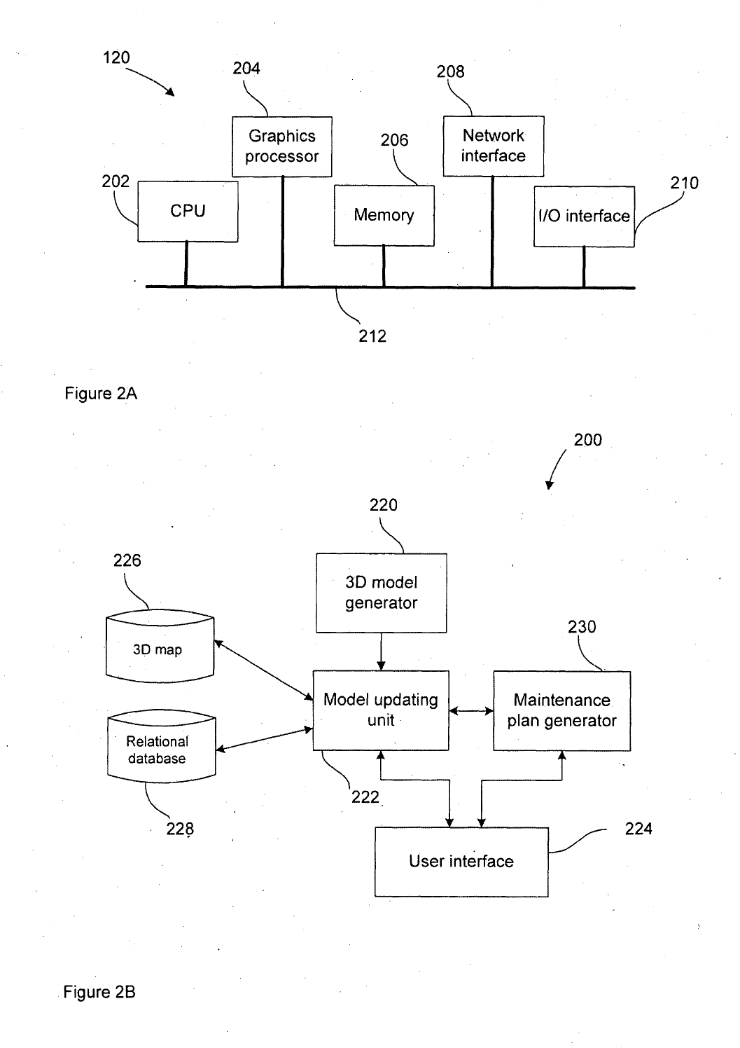

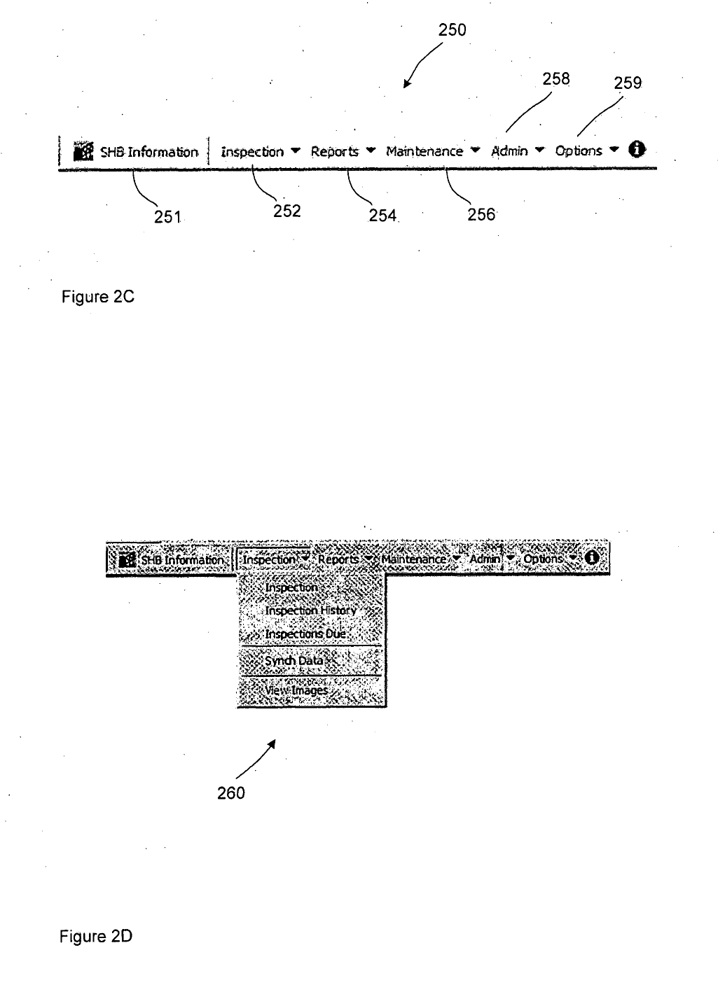

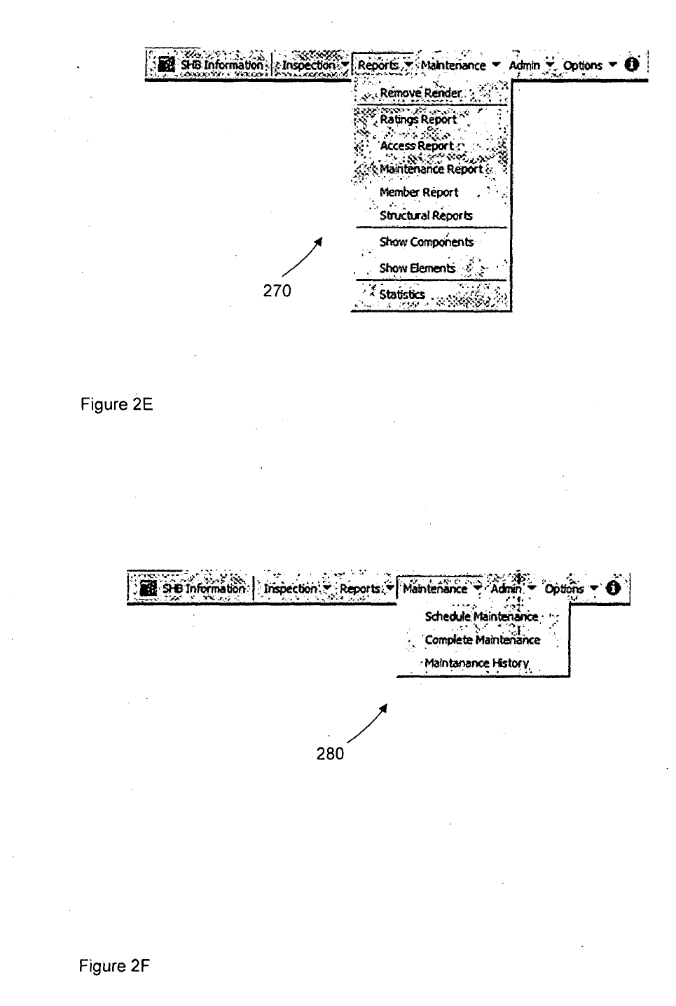

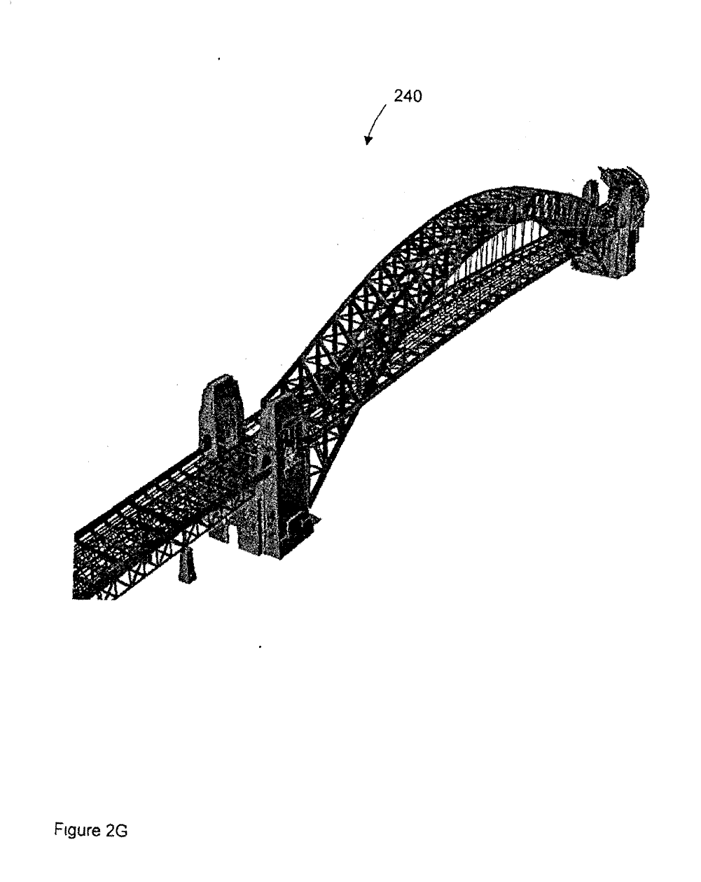

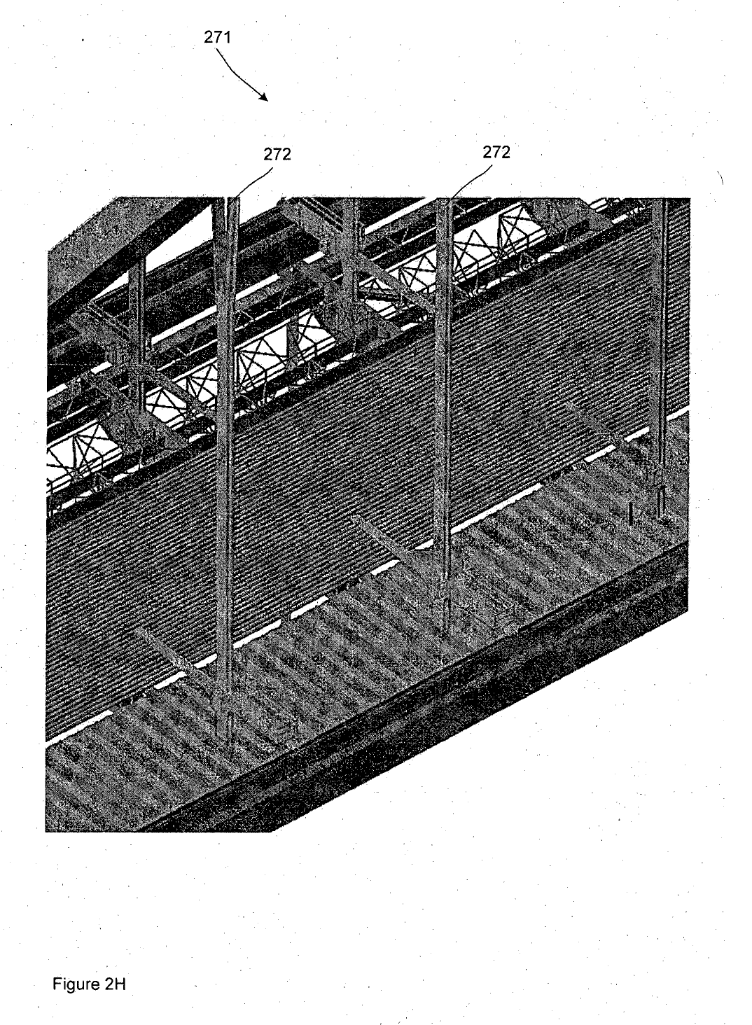

The computer hardware required for the computers 116, 118 and/or the main computer 120 typically comprises suitable components necessary to receive, store and execute appropriate computer instructions. The hardware structure of the system may be understood with reference to FIG. 2A. The hardware components include a central processing unit (CPU) 202, a graphics processor 204 (for example a NVIDIA GeForce GTX 590), memory 206, storage 124, a network interface 208 and an input-output interface 210 (such as a keyboard and monitor which are associated with the software user interface 224 as described below). Standard hardware also includes a bus 212 for communication between hardware components. The computer hardware operates with a software component 200 of the maintenance system 100 (described in further detail below), which is stored in the memory 206 and is executed by the CPU 202.

Apart from a standard operating system such as Windows, other software suitable to support the operation of a maintenance system as described herein include Microsoft® .NET Framework and a geographic information system such as ArcGIS v9.3 ArcEditor.

The storage device 124 interfaces with the hardware shown in FIG. 2A and could comprise any storage device suitable for the amount of data relevant to the specific structure. The storage device may therefore be a hard disk, a RAID system or other direct-attached storage.

It will be appreciated that there are many different possible computer architectures that may be used to implement the present invention and that the foregoing description is only one example architecture. The term ‘computer’ is used herein in a general sense and includes, without limitation the computational devices of personal computers, personal digital assistants, smart phones, tablet computers and servers. Those skilled in the relevant arts will immediately recognise which of these classes of computer can be used for each aspect of the maintenance system 100. For example, personal digital assistants, smart phones and tablet computers may be suitable alternatives to the laptop computers shown in FIG. 1 for the computers 116 and 118, but may not be suitable for the computer 120.

3. Software Structure and Process

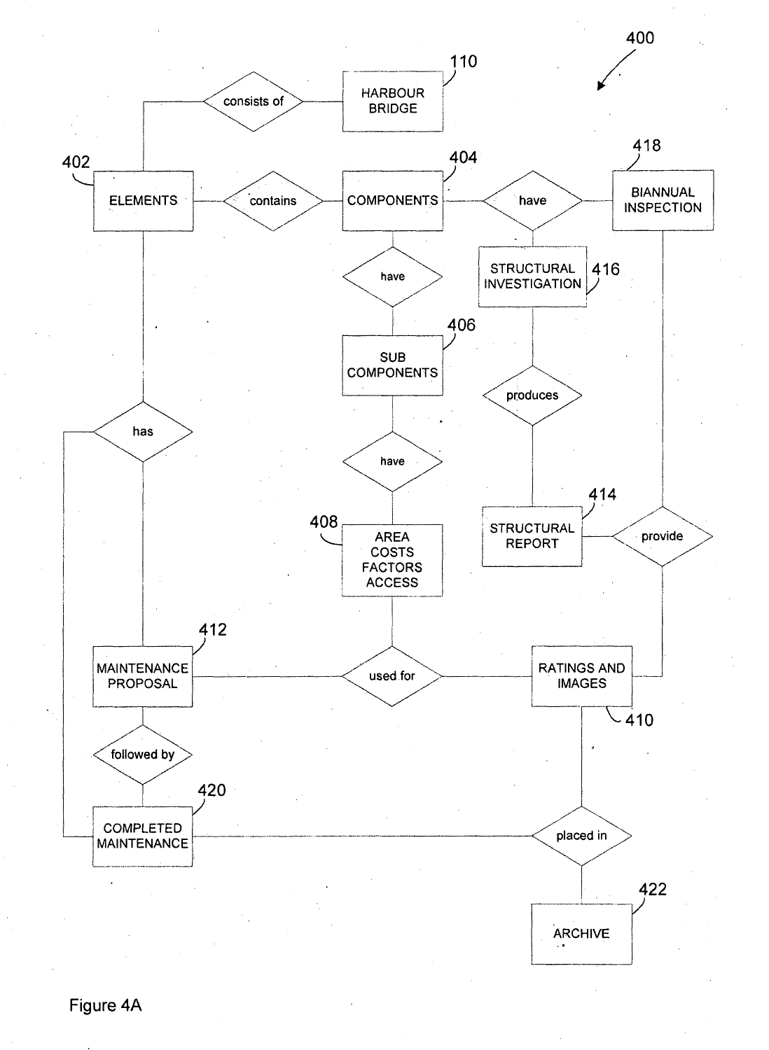

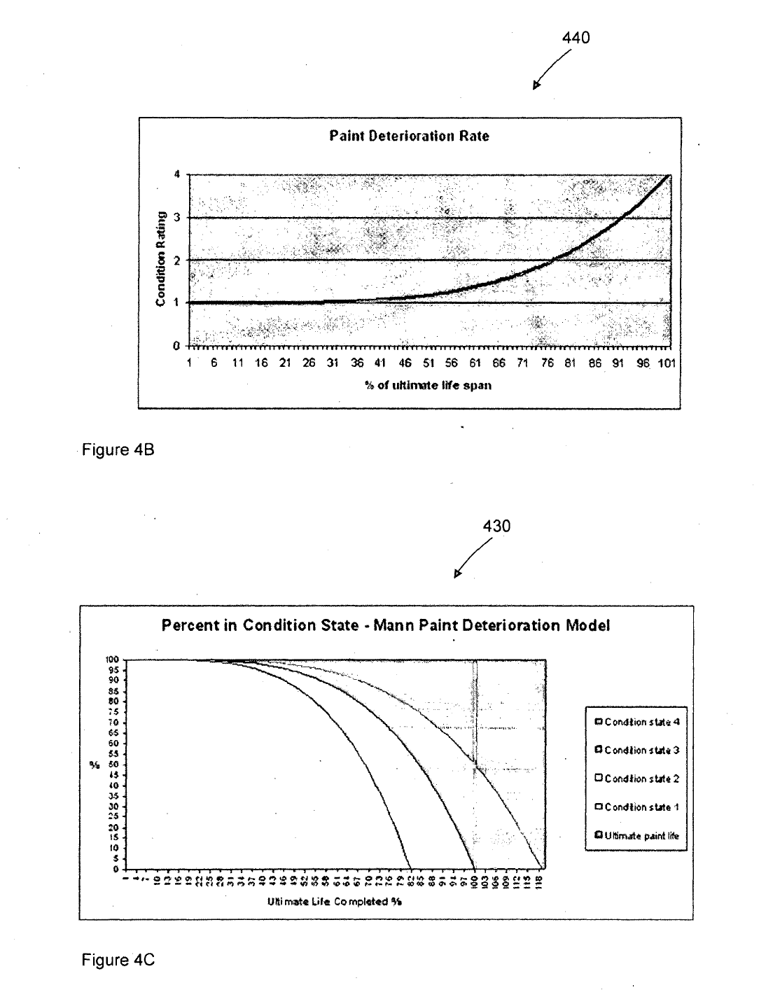

The software component 200 of the maintenance system 100 may be understood with reference to FIG. 2B. The software component 200 comprises a number of software units. The maintenance system 100 is initialised with structural information used to generate an initial 3D model using a 3D model generator 220. The model updating unit 222 updates the 3D model using inspection data input via the user interface 224. The data used by the 3D model generator 220 and model updating unit 222 comprises both an image representation called a 3D map 226 and a relational database 228. The 3D map 226 includes 3D rendering and colouring. The 3D map displays characteristics of the structure 110 using different colours, for example by using different colours for certain condition ratings (described in further detail below). The relational database 228, described further below with reference to FIG. 4A, is generated using a suitable database computer language such as SQL. The software component 200 also includes a maintenance plan generator 230 that uses maintenance parameters (input via the user interface 224) together with data from the relational database 228 in order to generate a maintenance plan. The maintenance plan is stored as part of the database and is output (e.g. displayed or printed) via the user interface 224 associated with the hardware I/O interface 210.

FIG. 2C shows a main user interface dialog 250 according to one embodiment of the invention. This main dialog 250 is used to access a number of different dialogs and menus relating to the inspection-maintenance process as described in more detail elsewhere herein. The information button 251 is used to view the 3D map of the structure. The map, in turn, shows the different areas of the structure, and when a user selects one of these areas (for example by clicking on the area), information relating to the components in that area is viewed. Information that can be viewed includes inspection and maintenance data, as well as structural data including calculated attributes such as the component area, A=length×width.

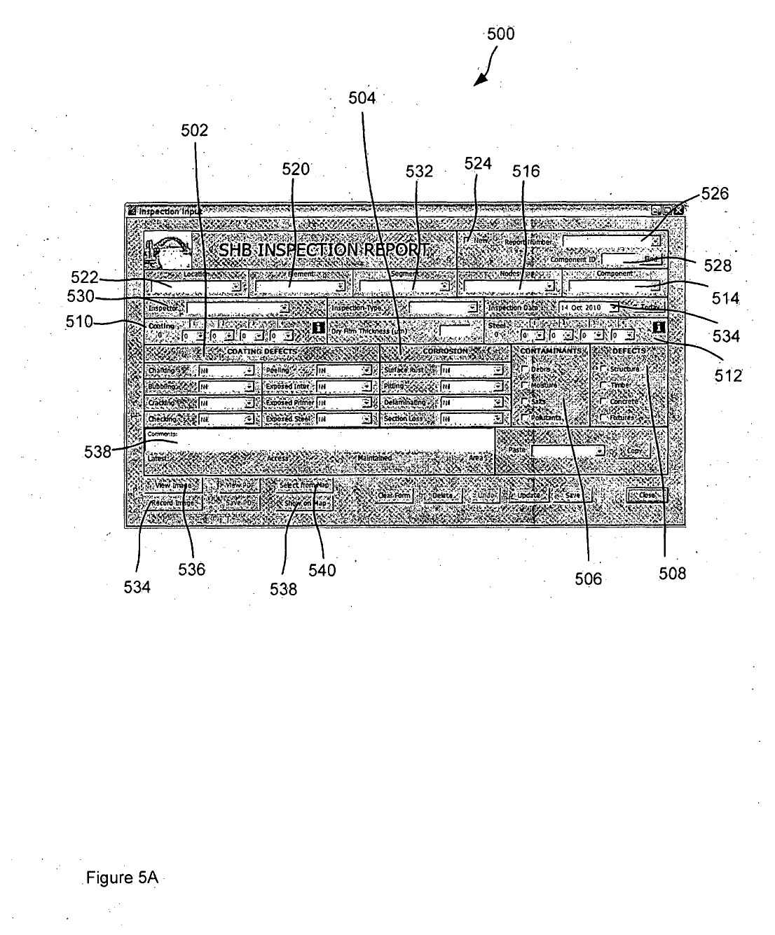

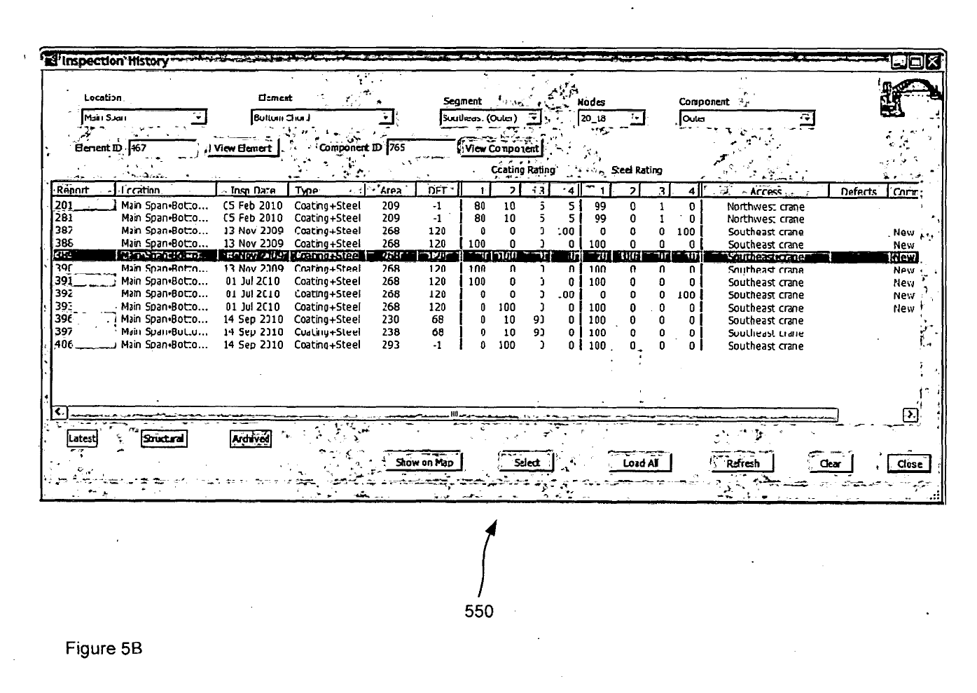

When a user selects inspection button 252 an inspection menu 260 (shown in FIG. 2D) is displayed from which selections can be made to display the inspection report 500 (shown in FIG. 5A), the inspection history 550 (shown in FIG. 5B), the inspections due, or view images. The synchronisation function can also be accessed from the inspection menu 260.

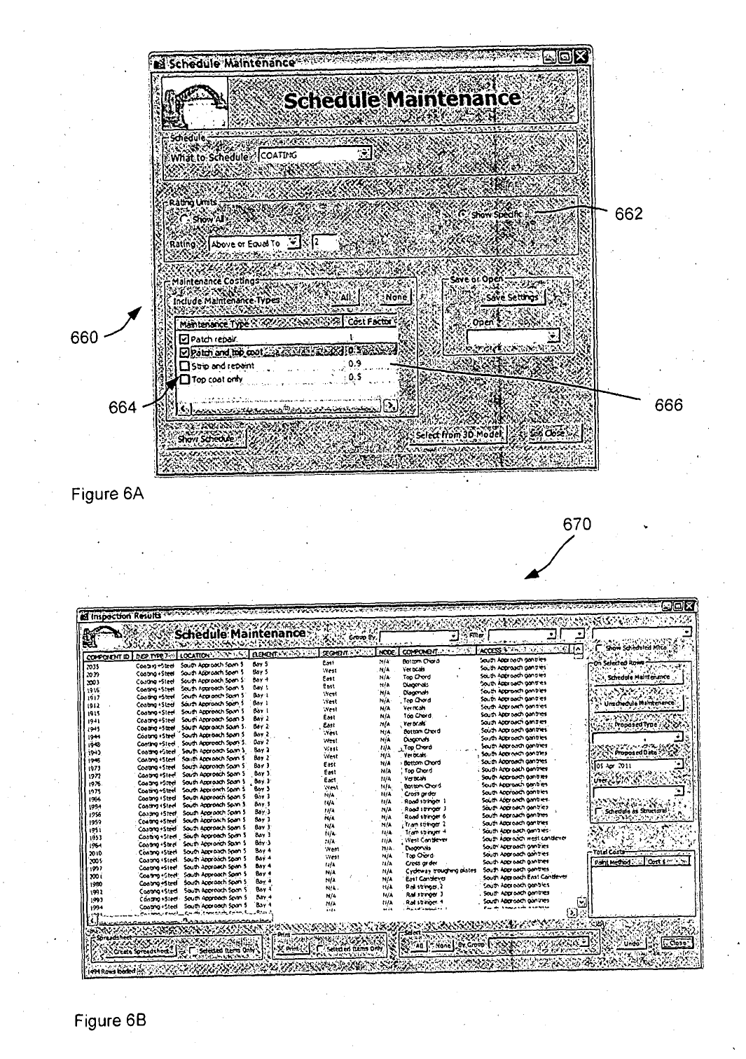

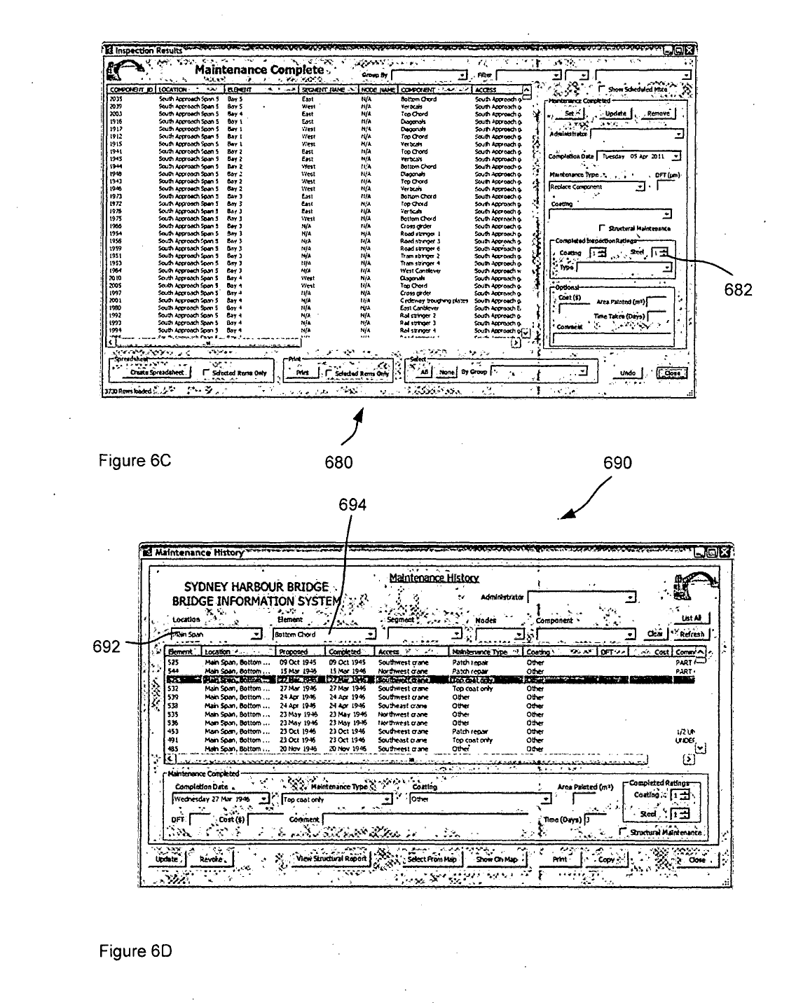

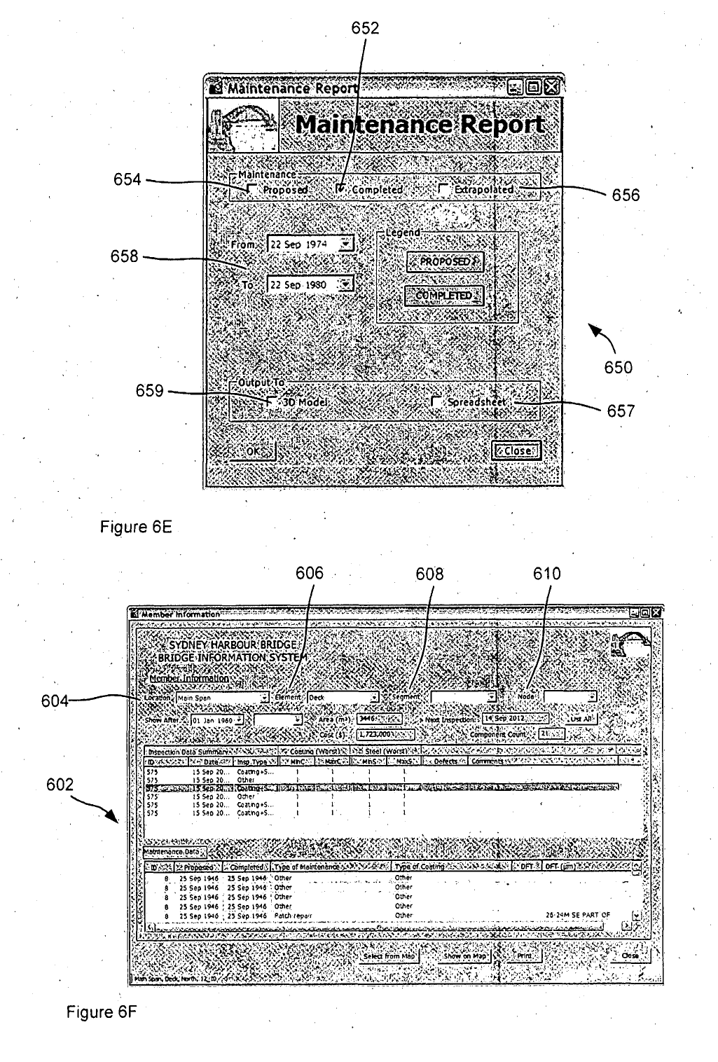

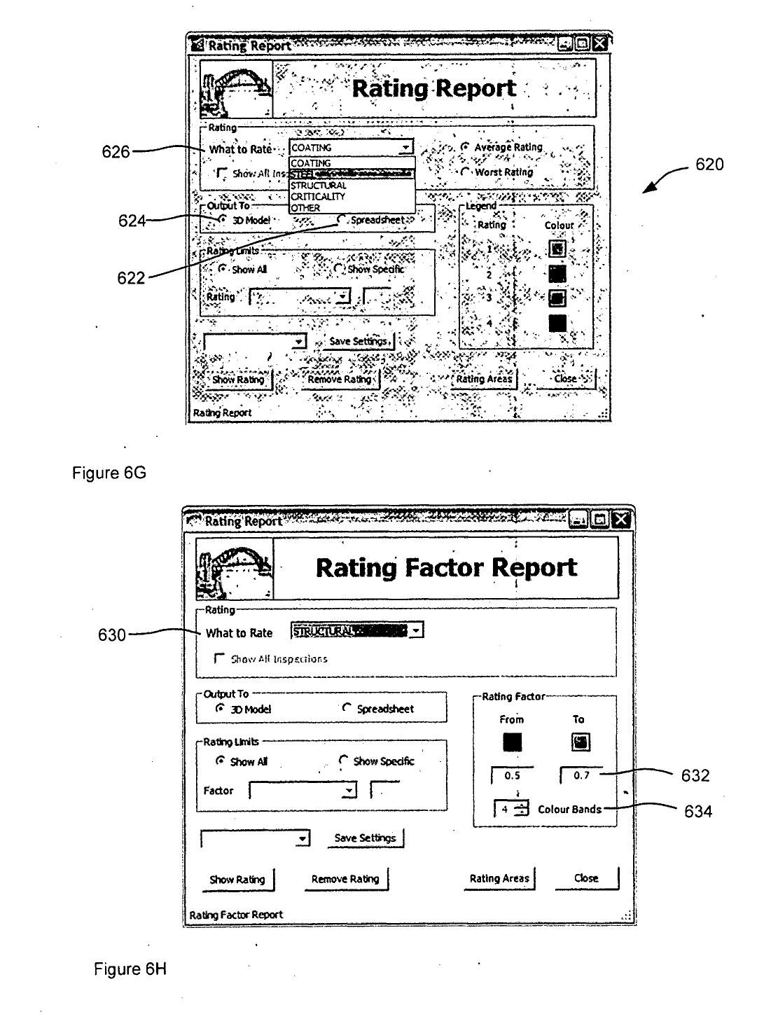

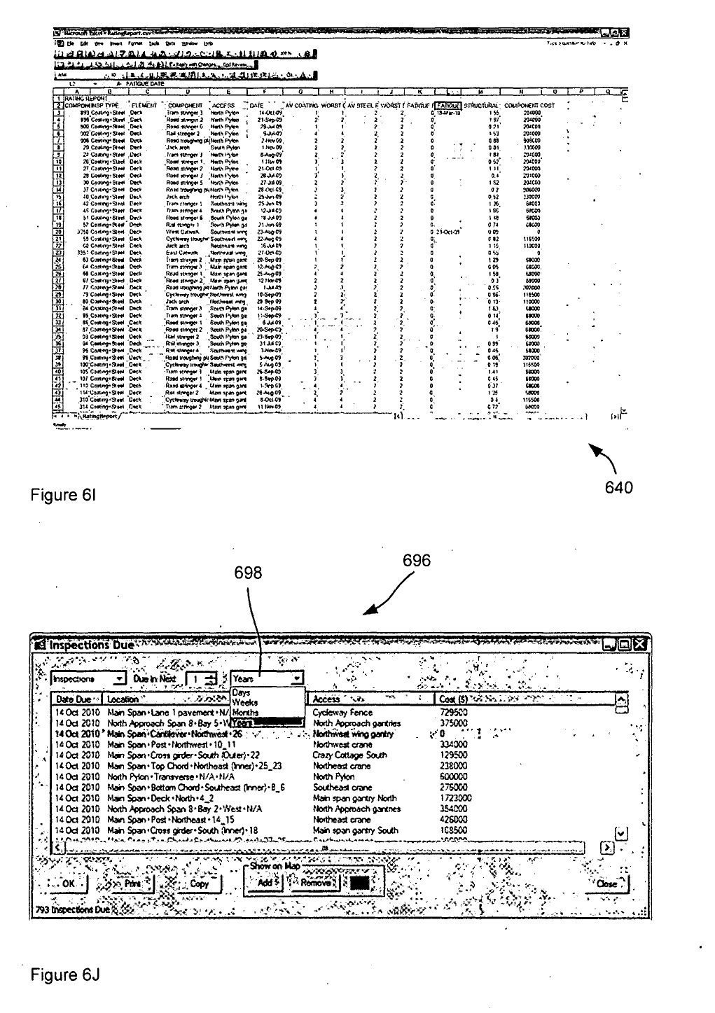

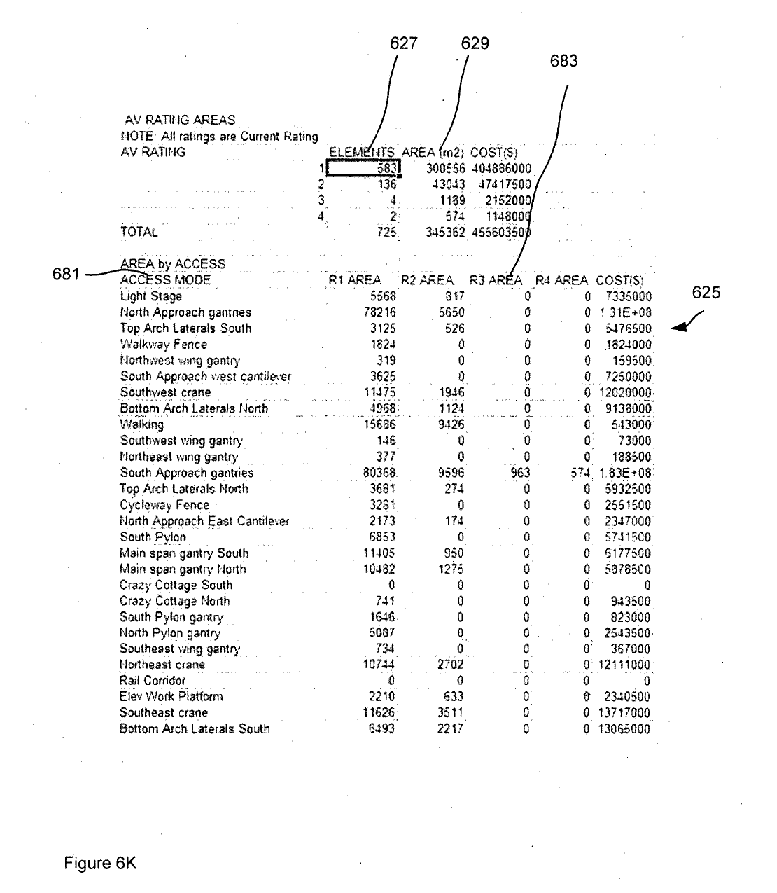

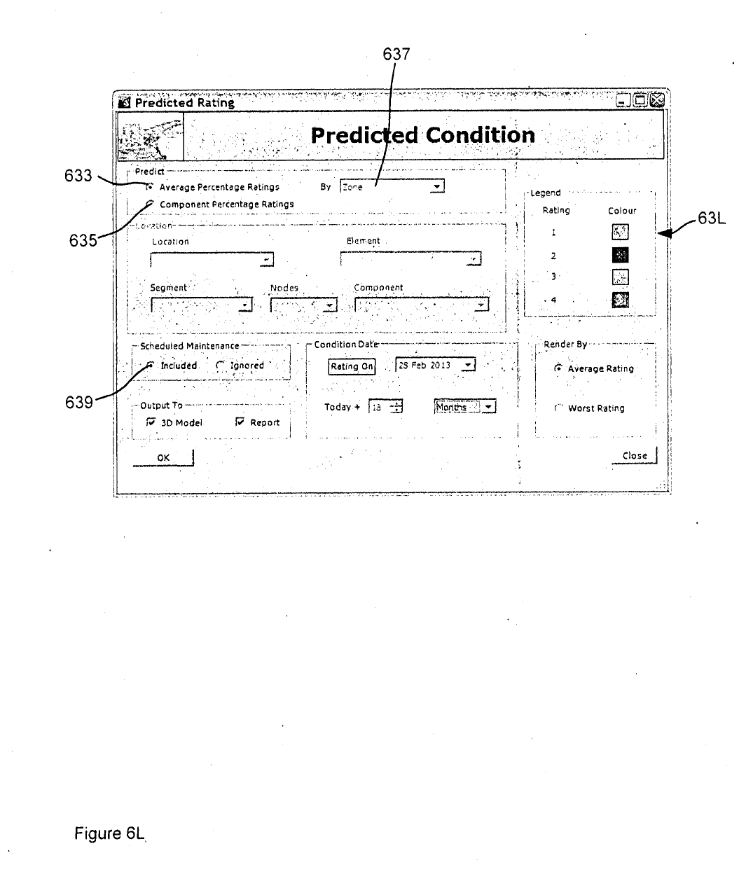

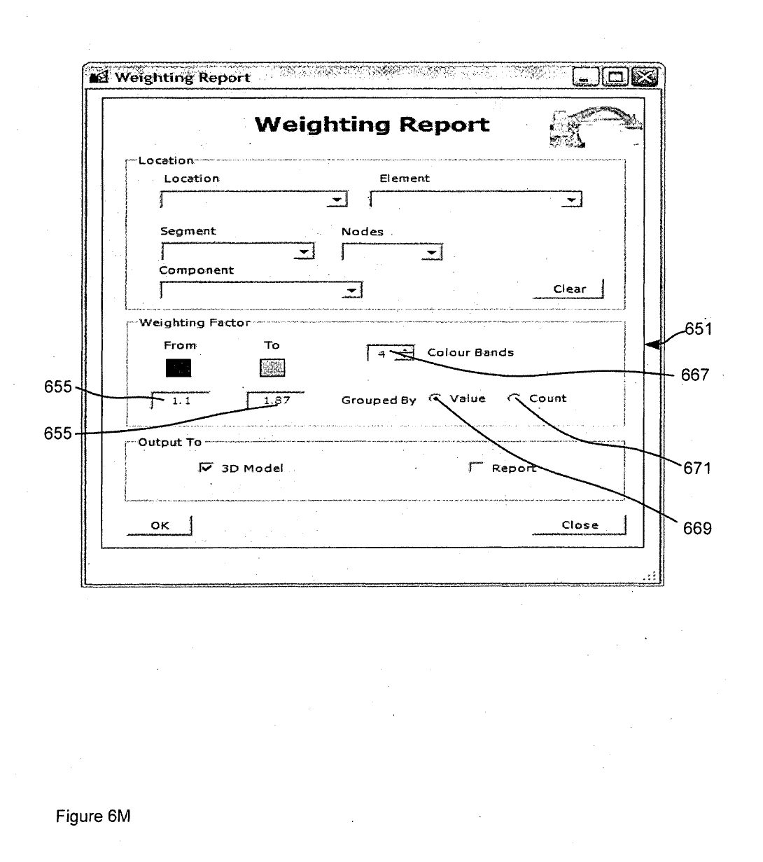

When a user selects the reports button 254 a reports menu 270 (shown in FIG. 2E) is displayed from which selections can be made to display a ratings report, access report, maintenance report, member report, structural reports, area report predictive rating report or weighting report. These are described in more detail below with reference to FIGS. 6E-6I. Lists of components or elements can also be shown from which reports can be selected. Statistical data formulated from the report data can also be viewed. It will be appreciated that the types of reports available will depend on the specific structure and circumstances, and may include other types of reports such as an area report

When a user selects the maintenance button 256 a maintenance menu 280 (shown in FIG. 2F) is displayed from which selections can be made to display the maintenance related dialog boxes described below with reference to FIGS. 6A-6D: maintenance schedule, completed maintenance and maintenance history dialogs.

The administration button 258 is used for administering and editing user details, access details to elements, the relational database and importing/exporting data. The options button 259 is used for setting the synchronisation options when master-slave synchronisation is performed as described elsewhere herein. It will be appreciated that the main user interface dialog 250 may comprise more or less or different buttons to access relevant functions.

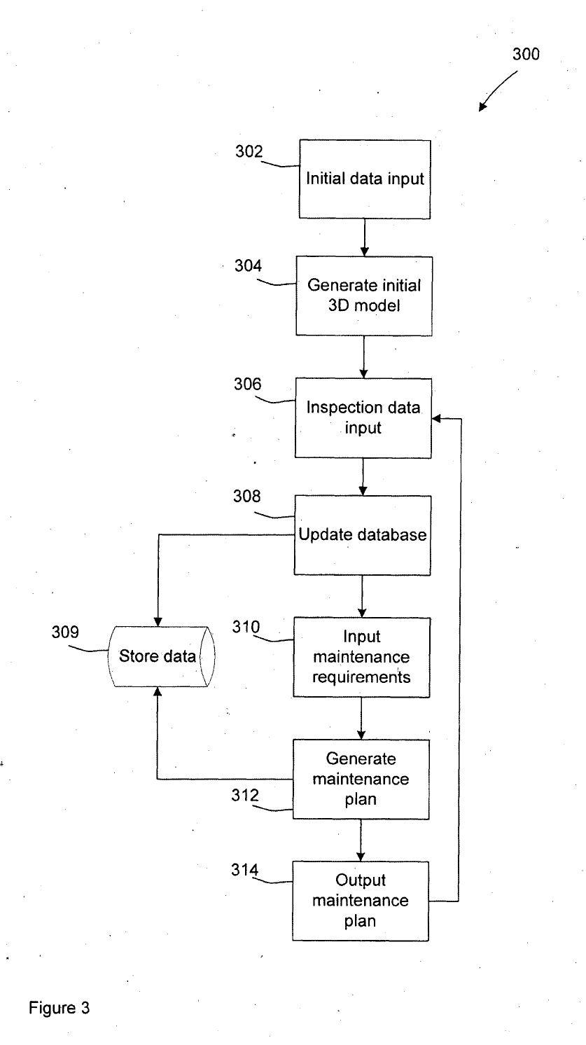

A software process 300 implemented by the software component 200 is shown in FIG. 3. After the initial data is input at step 302 the 3D model is generated at step 304 by the model generator 220. Inspection data is input 306 periodically for each component via the user interface 224 using an inspection report 500, following which the database is updated at step 308 by the model updating unit 222 that saves the data as part of the 3D map 226 and as part of the relational database 228. Subsequently, as part of the inspection-maintenance-inspection cycle, maintenance requirements are input via the user interface 224 and a maintenance plan is generated 312 by the maintenance plan generator 230. The maintenance plan is saved to the database and output via the user interface 224.

3.1 3D Model and 3D Map

A 3D model is used to maintain and update information available about the bridge 110. The 3D model is used to generate a 3D map that the user can use to inspect the information relating to the bridge 110.

The information used to generate the 3D model and for other processes of the maintenance system 100 is typically provided by subject matter experts such as a bridge engineer, maintenance manager, inspector and drafts persons. The information includes bridge drawings, the types of maintenance conducted (maintenance type) on the bridge, the types of inspections conducted on the bridge (inspection type) and for each bridge component the following data:
location, node name;
component name;
how the component is accessed (access method);
surface area;
aesthetic rating;
environmental rating;
expected life span;
structural fatigue factor;
structural rating;
segment name and the structural criticality;
weighting; and
paint system.

The information may further include types of bridge access, types of maintenance, types of inspection, location of each component, subcomponent details, defect types, coating type, inspection image types, rating criteria, staff table, staff permission type, and material type.

The 3D model is used to generate a 3D map for visual inspection of the information relating to the bridge 110. An example of a 3D map 240 is shown in FIG. 2G. FIG. 2D is a colour drawing showing colour rendering displayed on the 3D map. The 3D map 240 shows colour rendering associated with the structural condition rating of the components.

The colours shown depend on the version of the 3D map that is being viewed by the user. Versions include:
the condition ratings (coating, material or structural) of the various components;
weighting factor, predictive condition or access method of components;
inspection requirements (when inspections are due); and
maintenance completed, maintenance required and/or maintenance planned.

Each of these versions of the 3D map displays a differently rendered coloured map. The section below describing the reports generated by the maintenance system describes how the user inputs the required parameters into dialog boxes in order to generate and view one or more of the above versions of 3D maps.

FIG. 2H shows a close up of one node 271 in a 3D map selected to display maintenance planned. The colour rendering indicates that the upright portions 272 have been scheduled for maintenance.

In certain embodiments, activities are completed via the 3D map. For example, inspection data may be input by displaying the component to be inspected on a display, selecting that component using a suitable user interface, and then entering inspection data for the component in a form that is displayed in response to the selection of that component from the 3D map. In another example, past inspection data for a component may be viewed by selecting the component from the 3D map.

3.2 Relational Database

The relational database maintained by the maintenance system 100 can be described by the entity-relationship model (ERM) 400 shown in FIG. 4A. The entities in the model include the elements 402, components 404 and sub-components 406 of the structure 110, where each sub-component 406 is associated with area, costs, other relevant factors and access information 408. In embodiments without sub-components 406, then the area, costs, other relevant factors and access information is associated with the components.

This information 408 together with ratings and images 410 of the components/sub-components are used for a maintenance proposal 412. The ratings and images 410 are obtained from structural reports 414 following structural investigation 416, as well as from biannual inspections 418. Following the maintenance proposal 412, completed maintenance data 420 together with the relevant ratings and images 410 are placed in archive 422 (described below in further detail). The structural information input into the system forms part of the relational database, together with a weighting that influences the priority of the maintenance.

The weighting allows users to prioritise and allocate maintenance. Two components with the same condition rating, for example, may be maintained differently due to their weightings. This is a significant improvement from the common practice of having a maintenance schedule based on criticalities identified in inspection reports. For example, if 20 elements have the highest steel corrosion criticality rating of 4, asset managers are able to prioritise the maintenance schedule based on the weighting of each element. The use of aspects other than the condition rating (e.g. environmental and aesthetical weightings) in prioritising the maintenance schedule allows asset managers to approach asset management in a strategic manner. The weighting ensures all stakeholder interests are considered in the maintenance prioritisation e.g. structural engineers' concerns are addressed by the structural rating, the political aspect is addressed in aesthetic rating and the paint chemist's concerns are addressed in the environmental rating.

The weighting is determined according to the following formula:

$$weighting = ( \frac{environment\_rating}{10} + 1 ) \times ( \frac{aesthetic\_rating}{10} + 1 ) \times ( \frac{structural\_rating}{10} + 1 )$$

Each rating has a value from 1 to 4 to indicate the following level of importance:
1—neutral
2—moderate
3—very important
4—(only for structures) critical

It will be appreciated that any number of appropriate ratings may be used to determine the value of the weighting depending on the specific circumstances, and these may or may not include the three shown in the above equation. Also, the weighting may be determined in any number of ways in order to assist with the appropriate prioritisation of maintenance tasks. For example, instead of using a weighting value calculated to be between 1 and 2, the weighting may be calculated as a percentage.

The user can either enter a previously calculated weighting value directly into the dialog box, or the user can enter the variables of the weighting (e.g. the environmental, aesthetic and structural ratings), in which case the system will calculate the weighting in order to incorporate it into the maintenance plan. The manner in which the weighting is calculated, for example by using the above formula, is incorporated into the software of the system. It is possible to amend the formula used by the system, as well as add or remove one or more of the variables.

The condition rating of a specific element is multiplied by the weighting for that element, and the system then lists the scheduled maintenance tasks in order of priorities from the highest weighted rating to the lowest, enabling the relevant decision maker to schedule maintenance according to the calculated priorities.

The database includes a number of tables from which features are selected to describe the attributes associated with the various components, elements maintenance procedures and other aspects relating to the maintenance of the structure. Some of the relevant tables are listed in Table 1.

TABLE 1
Database tables and related data

| Table descriptor | Data in the table |
|---|---|
| Maintenance Type | Method of maintenance such as patch |
| Inspection Type | Types of inspection that can be performed e.g. |
| | coating and structural |
| Defect Level | 4 different defect levels are possible, from 1- |
| | no defect to 4- severe defect |
| Coating Type | A list of possible types of coating that can be |
| | applied to an element |
| Access Type | The various access methods |
| Image | Stores photos and images that are taken by |
| | inspectors |
| Permission | User permission for application |
| Rating | Inspection rating levels 1-4 |
| Defect Types | List of defect types: structure, timber, |
| | concrete, fixtures |
| Bridge Data | The Bridge structure components and |
| | weightings |
| Bridge Inspections | Inspection record for each component |
| Bridge Location | The values for location in Bridge Data |
| Bridge Maintenance | Maintenance record for each component |
| Bridge Subcomponents | Identification of Components which have |
| | subcomponents |
| Bridge Synchronisation | Synchronisation data |
| Bridge Staff | Staff list |
| Bridge Ratings Help | Help data |
| Zone | The table that is used to calculate averages in |
| | specific zones |
| Treatment | Maintenance treatments for each material |
| | such as spray seal |
| Material | List of Materials making up structure |
| Area | Component Area calculation |

4. Entering Inspection Data

The user interface 224 provides for the input and output of information:
Information input includes inspection data entered, into the system, as described in this section.
Information input also relates to parameters defining the reports required by the user. These reports together with relevant 3D maps are then output (displayed on a screen and/or printed), as described in the next section.

In the embodiments described herein, the input of inspection information is performed by a number of dialog boxes, such as Windows forms. Other inspection information entered via the user interface 224 include the date, operator name, and component location, as well as information relating to the condition of a component. This information includes a rating level, condition items such as peeling or cracking, structural characteristics such as cross-sectional area and crack length, and the details about the required maintenance activity such as the cost and schedule. Other information includes the visibility of the component to the public, as well as how access is obtained to the component. Some aspects of this information may be entered when the maintenance system 100 is first formed, while other aspects may be null until later, for example until the first inspection has been completed.

Following each inspection, each component is allocated a rating for the specific type of condition being rated. The rating has a value between 1 and 4 that is also associated with the percentage of the component's area affected by that rating. In other words, a component in very sound condition will have 100% of its area as rating 1. Another component, having 75% of its area in sound condition and 25% in very poor condition will be 75% rating 1 and 25% rating 4. These values will be entered into the database.

Each component is assigned a percentage of its total area for each rating level. The resulting rating values are combined for all the components in a node to give a single rating value for that node. The rating value for the component can be the average rating or the worst rating. As an example: if a component has a rating of 4 over 1% of its area and a rating of 1 over 99% of its area, then the value of the average rating assigned is 1 whereas the worst rating value assigned is 4.

4.1 Paint Condition Rating

The equation below (Eq. 1) quantifies the behaviour of paint deterioration, derived through empirical testing performed on the Sydney Harbour Bridge.

$$Y = 100 - ( \frac{1}{z} ) \times {X}^{4} \qquad Eq . 1$$

The coefficient “z” is a number that specific to each condition state which essentially defines the parameter of each condition state used by the asset manager. In turn, “z” determines the rate of transition between each condition state with reference to the “paint system factor” and the “environmental rating factor” of the infrastructure in question. In one embodiment the coefficient “z” is between 100,000 and 10,000,000. “X” is the percentage of the life span elapsed which will be discussed below.

A paint rating system classifying paint condition within a scale of 1 to 4 is used. When paint is applied to the bridge steelwork the initial rating is set at 1. Over time the paint will age and towards the end of its useful life the rate of deterioration will increase. This gives rise to an exponential deterioration curve. A condition rating of 4 represents the end of the paint's useful life and the upper limit to the deterioration curve. Thus the paint condition can be described in the following example equation Eq. A which is derived from Eq. 1:

Paint Condition Rating, Y=1(3×10⁻⁸×X⁴), if X>100 then Y=4 Eq. A

where X is the percentage of the life span that has elapsed where life span of paint is defined as follows:

Life span=10×(Paint system factor)×(2−0.5×Environmental Rating factor) Eq. B

where the paint system factor is as follows:
Chlorinated Rubber system=1
Epoxy system=2
   and the environmental rating factor is as follows:
Neutral impact=0
Important impact=1
Very important impact=2 (harsh environmental conditions)

FIG. 4B shows the paint deterioration rate 440 according to Eq. A.

Using Eq. B, the paint life span varies, for example from 10 to 40 years, in 5 year increments. With detailed paint deterioration records becoming available over time, consideration may be given to adjusting both factors defined above. Irrespective of the life span for any particular element component, the shape of the deterioration curve according to Eq. 1 remains constant.

As the paint on a component ages, it is expected that some parts of that component will deteriorate at a different rate. This may be due to parts being relatively more sheltered from the environment, or subject to quality inconsistencies or local damage. Hence, from the time a component is painted, the paint condition rating at a future date may comprise a percentage in each of the four condition states, possibly including 0% and 100%. The deterioration curve therefore represents a line of best fit for a combined average of the four condition states.

The variability in the paint's performance over time is represented by the Paint Deterioration Model 430 shown in FIG. 4C. The acceleration in the deterioration is defined by exponential curves to the power of 4 marking the transition of one condition rating into another and which are calibrated against known paint deterioration data.

For example, on the Sydney Harbour Bridge the following equations have been used to define each condition state used by the asset manager:

The curve dividing condition state 1 and 2 is defined as:

Percent in condition state, Y=100−(1/450,000)×X⁴

The curve dividing condition state 2 and 3 is defined as:

Percent in condition state, Y=100−(1/1,000,000)×X⁴

The curve dividing condition state 3 and 4 is defined as:

Percent in condition state, Y=100−(1/2,000,000)×X⁴

X=% of life span elapsed

At 100% of the ultimate life, all paint on an element component of the bridge will be in condition state 3 and 4. Beyond this time some residual paint may still be providing protection to the steel until the point when no paint remains but it is considered that the paint system as a whole has failed and renewal of the system needs consideration. Depending on asset management target condition states, maintenance painting intervention is likely to be triggered at some point before the ultimate paint life is reached.

When a user inputs the inspection data for paint condition, the user can enter the rating value between 1 and 4 directly into the inspection dialog box. In a further embodiment, the variables required to calculate the paint condition as described above are entered, and the system calculates the inspection data according to the above equations: the system calculates the paint life span that has elapsed and/or the system calculates the paint condition. For this, the user will enter a value for the environmental rating and/or the paint system factor.

In a further embodiment the system calculates the rate of paint deterioration according to Eq. A, an example of which is shown in FIG. 4B.

In a further embodiment, the equations used by the system to determine the paint condition, paint life span and rate of paint deterioration may be amended by the user, including adding or removing one or more variables.

4.2 Coating Condition Rating

The coating defects rating values are determined as per table 2 below:

TABLE 2
Coating defects guide

| Rating | Description |
|---|---|
| 1 | The protective coating is generally sound and unbroken. |
| | Some minor chalking and water staining may be evident. |
| 2 | The protective coating is exhibiting: |
| | Minor speckled white or red rusting, and/or |
| | Localised pinhead rusting, and/or |
| | Localised peeling and/or flaking. |
| | The top coat may exhibit one or more of the following |
| | conditions: |
| | Loss of thickness |
| | Primer exposed over localised areas |
| | Shrinkage lines with minor localised splitting |
| | Surface checking with slight localised splitting |
| | Minor unbroken blistering. |
| | Rivets may be exposed at scattered locations. |
| 3 | The protective coating is exhibiting: |
| | Speckled white rusting in areas >2% and <5% of total surface |
| | area. |
| | Speckled red rusting in areas >0.5% and <5% of total surface |
| | area. |
| | The top coat may exhibit one or more of the following |
| | conditions: |
| | Primer exposed over large areas. |
| | Splitting and peeling (loss of adhesion) |
| | Heavily checked blistering over large areas. |
| | Numerous rivets may be exposed. |
| 4 | The protective coating is no longer effective, signs include: |
| | Speckled rust >5% (red and white) |
| | Failure of primer over large areas. |

4.3 Steel Condition Rating

The steel corrosion rating values are determined as per table 3 below:

TABLE 3
Steel corrosion guide

| Rating | Description |
|---|---|
| 1 | There is no evidence of corrosion. |
| 2 | Surface rust or minor pitting has formed or is forming. |
| | There may be exposed metal but there is no measurable |
| | loss of section. |
| | There may be minor deformations that do not affect the |
| | integrity of the element and there are no cracks in the |
| | steel or welds. |
| 3 | Corrosion is moderate - heavy pitting may be present. |
| | Some measurable section loss is present locally, but not |
| | critical to the structural integrity and/or serviceability |
| | of the component. |
| | There are minor cracks and/or deformations in the steel or |
| | welds which have been assessed as being not sufficient to |
| | impact on the ultimate strength and/or serviceability of the |
| | component. |
| 4 | Corrosion is advanced. |
| | Section loss is sufficient to warrant analysis to ascertain |
| | the impact on the ultimate strength and/or serviceability of |
| | either the element or the bridge. |
| | There are cracks and/or deformations in the steel or welds, |
| | which may impact on the ultimate strength and/or service- |
| | ability of the component. |

It will be understood that a number different component features may be allocated ratings, and that the ratings may be allocated according to a variety of scales and characteristics, as applicable to the specific complex structure being maintained.

4.4 Entering Inspection Data into the System

Referring to FIG. 5A, inspection data is input to the system via an inspection report dialog box 500. A new inspection report can be generated if the New field 524 is selected, or an existing inspection report number 526 can be entered to retrieve the appropriate report that will be updated. Other options available for the user to retrieve the appropriate inspection report for entering inspection data are as follows:
1. A component identification name or number 528 can be entered to search the relevant component;
2. Selecting a location 522 (typed in or selected from the drop down menu) will provide a list of elements 520, segments 518, nodes 516 and/or components 514 that can be selected. The components 514 may be associated with one or more of the elements 520, segments 518 and/or nodes 516 so that the user is able to cross-reference and use available information to search for the required component;
3. If the user selects the Select from Map 540 button then a 3D map is displayed on the screen to allow the user to visually inspect the bridge 110 in order to select (e.g. by clicking on) a specific segment or component.

Auxiliary information relevant to the inspection report includes the inspector details 530, the inspection type 532, and the inspection date 534. Inspection types include coating and steel inspection of the component's paint and steel condition, structural inspection of the structural capability of a component, and inspection of components such as concrete and stonework. Consequently the inspection data relates to the coating, structural condition or concrete/stonework condition of a component 514. It will be understood that other types of inspection reports may be used as appropriate to the circumstances of the specific structure.

The inspection report 500 shown in FIG. 5A is used for entering coating condition data. With respect to the coating, data that is input and stored in inspection tables includes the coating rating 510 and the steel rating 512. For both of these, a rating between 1 and 4 is available, and for each one of these ratings the percentage of the surface area associated with the rating is entered using the four drop down menus.

Data relating to user defined defect type such as coating defects 502 includes the percentage of surface area subject to one or more of chalking, bubbling, cracking, checking, peeling, an exposed inter layer, and exposed primer layer, and exposed steel.

Data relating to user defined defect such as corrosion 504 includes the percentage of surface area subject to a user deterioration condition such as one or more of surface rust, pitting, delaminating and section loss.

The presence of user defined contaminants 506 can be recorded for debris, moisture, salts and/or pollutants. The presence of other defects 508 can be recorded for structure, timber, concrete or fixtures.

Images are stored in an image table. To record an image the user selects the Record Image button 534. To view a recorded image the user selects the View Image button 536. Other relevant comments can be entered into the comments field 538.

With respect to the structural condition, the data that is input and stored includes the structural rating, the structural factor and image data. The structural factor is an engineering factor of safety. For an element that is less then 1.0 it means the element is under designed (capacity) and if over 1.0 the component is overdesigned (capacity). The structural factor may change with time according to the load that the bridge is exposed to if the load the bridge experienced was significantly less at the time of design than the load that the bridge experiences at a later stage.

The inspection history can also be viewed via the system user interface by accessing the inspection history panel 550 shown in FIG. 5B.

5 Generating a Maintenance Plan

From the main menu, the user is also able to access a maintenance interface for specifying maintenance parameters, viewing maintenance options, and selecting a maintenance plan.

The maintenance process involves three main steps:
first selecting the required maintenance parameters for which a list of possible maintenance options is then generated showing the inspection data for the relevant components;
selecting maintenance options from the list for a final maintenance plan; and
then performing the maintenance and updating the inspection data for the components that have been maintained.

Referring to FIG. 6A, maintenance parameters are entered using the maintenance schedule dialog box 660. Specific maintenance parameters can be entered if the “Show Specific” 662 button is selected. The user can select a certain rating value to view inspection data for elements or nodes that share a certain rating in order to include those elements/nodes in the maintenance plan. For example, the user may select to view coating ratings below 2.

In alternative embodiments available options in the dialog box for selecting maintenance parameters include selecting a specific access route, a criticality rating and/or a condition rating. Additionally, the user may select to view coating ratings below 2 that are associated with nodes that have a high criticality rating (where high criticality ratings relate, for example, to nodes that are visible to the public or are structurally critical). Alternatively, inspection data can also be viewed according to the access method associated with the specific element or node as shown in the scheduled maintenance form 670 in FIG. 6B.

When scheduling the maintenance, the user can also view inspection data associated with a certain proposed cost for the maintenance. This includes the cost of full maintenance access setup, painting and access dismantling. A specific cost limit can be entered, for example a dollar value. Alternatively, as shown in FIG. 6B, the required maintenance type 664 can be selected, and each is associated with a certain cost factor 666.

As will be understood from the above description, a maintenance plan can be based on one of, or a combination of the following maintenance parameters:
a condition rating,
a criticality rating,
an access method and/or
a proposed cost.

The scheduled maintenance form 670 in FIG. 6B shows the list of maintenance options according to the maintenance parameters input by the user. The user is able to select the maintenance options required for the maintenance plan from this list, or to select the entire list. Once the user has selected the maintenance to be scheduled, the proposed maintenance data is saved in the database and can also be viewed on a maintenance 3D map (for example, as seen for node 271 in FIG. 2H).

The scheduled maintenance can be altered using the maintenance completed dialog box 680 shown in FIG. 6C. For example, for each element maintenance may be revoked or marked as completed in which case the completed condition rating 682 is changed to, for example, 1 (pristine condition). All inspections recorded as a result of maintenance are entered into the inspection table using a “Maintenance Inspector” function.

The maintenance history of each element can be viewed using the maintenance history dialog box 690 shown in FIG. 6D. If maintenance is carried out that is not an outcome from an inspection, the components are selected using the drop down menus for location 692, element 694 etc., and the maintenance details are filled in and saved.

6. Reports Available for the User

From the main menu the user is also able to access a number of reports that include information about how a component is accessed, inspection data relating to component features, e.g. the condition of each component (for example using rating levels), and the criticality of each component. Criticality can be determined according to the requirements of the structure 110 and may be based on, for example, visibility of the component: the more visible the component is, the more critical it is to prioritise the maintenance of that component.

6.1 Maintenance Report

Referring to FIG. 6, a user uses the maintenance report interface 650 to specify the parameters for which a maintenance report will be generated and displayed, printed and/or saved. In particular, the user specifies if the report must include data relating to maintenance completed 652, the proposed maintenance 654 and/or the maintenance required at a future time, extrapolated maintenance 656. In the maintenance report dialog box 650 the user specifies relevant start and stop dates 658. A spreadsheet 657 and/or 3D map 659 of the bridge can then be viewed showing proposed and/or completed maintenance of the various components. The 3D map shows the proposed and/or completed maintenance as different coloured shading of the various components.

6.2 Member Report

Referring to FIG. 6F, the member report 602 displays the inspections that have been carried out on a particular node. The user enters location 604, element 606, segment 608 or node 610 details to access the relevant inspection and maintenance data. Data can be limited according to the earliest date selected by the user as well as the number of years selected.

Reports can also be generated by referring to the 3D map. If the 3D map is used, then the location, element, segment or node is selected by clicking on the relevant area on the 3D map.

If a node has been selected and the maintenance data for that node has been displayed, then the detailed data for each element can also be accessed. Each of the components making up the node is displayed with its rating data.

6.3 Condition Rating Report

Referring to FIG. 6G, a report showing the rating values for each component can be created using the rating report dialog box 620. The report is output as a spreadsheet 622 or coloured on the 3D map 624. Rating reports can be generated according to the aspect that is rated 626, for example coating, steel, structural condition or criticality.

The average and/or worst rating can be displayed on the 3D map and provided in a spreadsheet output. The spreadsheet is opened when the report is available to view. The report can be saved or discarded after viewing.

A subset list of ratings can be reported. For example, if the user selects a “comparison” function, then having a rating equal to, above or below the selected rating will be shown (e.g. choosing above or equal to and the value 3 will select all components having a current rating of 3 or 4).

A user-definable colour is displayed for each rating on the 3D map. The user can also remove the colour rendering from the 3D map and the image will be displayed in grey-scale. Rendering is not a function of the 3D modelling platform (ARCobjects). Rather, the user defines the colour associated with an attribute via a command in the 3D modelling software.

Referring to FIG. 6H, if the user has chosen a structural report 630 then the report is generated using a pair of limits 632 on the structural factor of a component. The structural factor is described elsewhere herein in more detail. The rendering is divided into the number of colour bands 634 selected by the user (for example 4 bands for a rating between 0.5 and 0.7).

6.4 Area Report

A report showing the total area for each rating value and the area per rating per access method can be output to the user. This is in the form of a spreadsheet 640 containing the data for each rating as shown in FIG. 6I.

6.5 Access Report

A report of the access method for each bridge component is available. This report shows the access by shading the components of the 3D map. The user selects an access zone to display and a colour to represent it by using an access report dialog box. Reports may be generated according to a node or location selected by the user, for example by selecting a location using the 3D map. Alternatively, the user can select an access method to produce a report of the elements or nodes accessible via the particular access method. These reports can be saved and accessed again at a later stage.

6.6 Inspections Due Report

Using the inspections due form 696 as shown in FIG. 6J, a user can specify a certain time frame for which details of inspections due is required. The list of inspections due is for painting maintenance and/or fatigue maintenance.

When an inspection is completed, the date of the next inspection is set according to a predefined inspection interval using the drop down menus 698. For example, the next inspection may be set as one year from the date of inspection. The next inspection date may be specified by an asset manager. In this case it may be displayed as a default value, with or without an option to amend. The fatigue date is ascertained by the bridge engineers and set in the database.

6.7 Area Report

A report showing the total area for each rating value, and the area of each rating per access method can be displayed by selecting the rating areas button 623 on the rating report dialog box 620.

This generates a spreadsheet 625 as shown in FIG. 6K which shows the total number of elements 627 in each rating value as well as an aggregation of the area 629 in each rating value. This gives the maintenance manager an idea of the total health of the structure.

The area report also gives the maintenance manager an idea of the maintenance requirement in relation to each of the access methods 681. The access based values 681 are set out in the lower part of the spreadsheet 625 and show the sum of the areas for each rating value 683. This advantageously assists the maintenance manager in allocating resources for maintenance based on availability of the access methods.

6.8 Predictive Rating Report

Users are able develop a forward maintenance plan based on a possible condition in a future period created through the predicted condition report dialog box 631. The users can select average percentage rating 633 or component percentage rating 635 for a specific zone or component 637 and either include 639 or exclude 641 scheduled maintenance. The output can be displayed on 3D map, spreadsheet or PDF format.

6.9 Weighting Report

The Weighting Report can be generated through the weighting report dialog box 651 to show the weighting factor for each component 653 on a structure or the components which lie within a particular weighting factor range. If the weightings are being rendered on the 3D model then a set of colour bands can be chosen 667 to create a graded colour scheme. If necessary the values 669 shown in the 3D Model can be grouped by weighting value 669 or by the count of components 671 having a weighting within a particular range in the 3D Model Table of Contents. This will affect the colour they are assigned.

7. Master-Slave Synchronisation

If the system is implemented in an embodiment comprising a master 120 and slave computers 116, 118 as shown in FIG. 1, then inspection data entered into the local database of a slave computer 116, 118 needs to be uploaded to the master computer 120. This process is called synchronisation, and includes updating the mirror database on the slave.

Referring to the slave computers 116, 118, the 3D map displayed on each of these computers is connected to a slave database residing on the local hard-disk and so is one of many such databases that are resident on other slave computers forming part of the system 100. Each slave database needs to be updated or synchronised with the master database prior to the addition of any new information.

During the synchronisation process, inspection and maintenance data from the slave database are transferred to the master database. At the same time, records from the master database are transferred back to update the slave database.

Before any inspection data is saved, the local database is synchronised with the master database via the network 122. To carry out synchronisation the slave computer 116, 118 is first connected to the network 122, the master database is then located over the network, and the synchronisation function of the system 100 is enabled. Once the slave database has been synchronised, new inspections can be saved and existing ones updated. The slave database will also contain inspection and maintenance data entered by all other slave computers forming part of the maintenance system 100.

8. Archiving

For a complex structure comprising thousands of individual components, a complete inspection cycle takes about 2 years. Referring again to FIG. 4A and the archive entity 422, once a component has undergone a cycle of inspection-maintenance-and inspected again, the first inspection and the maintenance that has been completed become redundant and are archived.

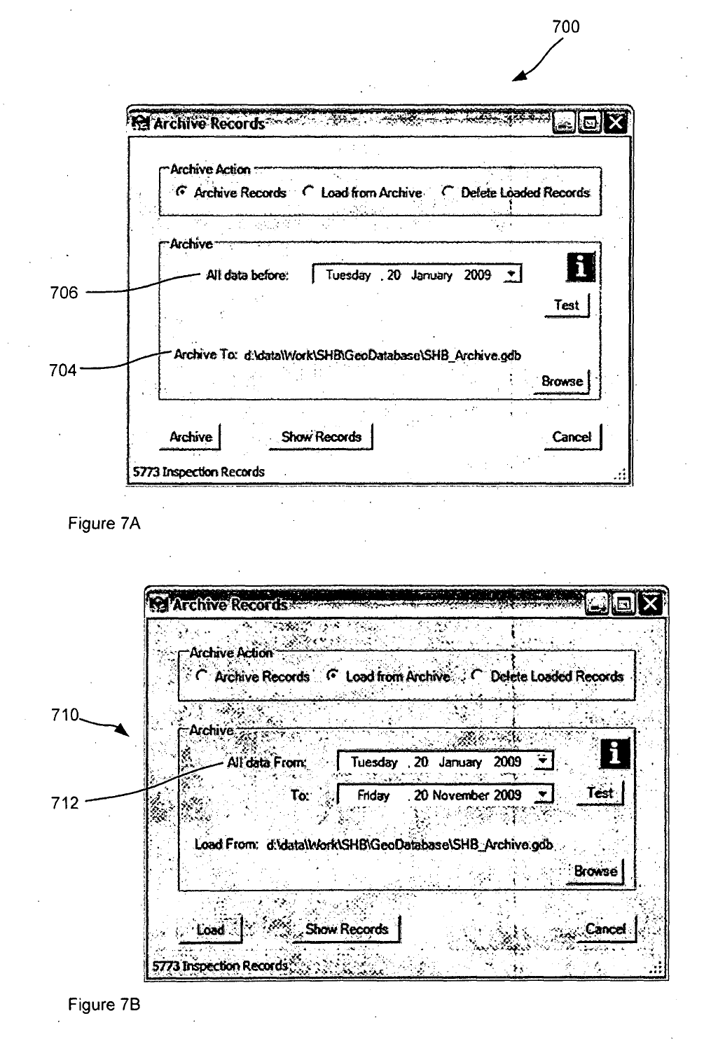

Referring to FIG. 7A, the user interface 224 includes a dialog box 700 to facilitate archiving. The inspection data as well as the completed maintenance tasks that the user wishes to archive can be selected using the archiving dialog box. To assist in the task of archiving records, a graph of the accumulated records can be produced. This allows the most suitable archive date to be chosen.

In order to archive records, the user selects an archive database 704. The software program provides a list of directories from which an appropriate database can be selected. Following this, an archive date 706 is selected by the user. The system includes an option to view the number of records associated with the user's selection.

Records in the archive database may be loaded back into the user database for comparison and other history gathering uses by using the dialog box 710 shown in FIG. 7B. To load records from the archive, two dates 712 are selected by the user (from and to) to select which records to load. All the archive records between these dates will be loaded. An option to view the number of records associated with the user's selection is included.

As used herein, except where the context requires otherwise, the term “comprise” and variations of the term, such as “comprising”, “comprises” and “comprised”, are not intended to exclude further additives, components, integers or steps.

It will be understood that the invention disclosed and defined in this specification extends to all alternative combinations of two or more of the individual features mentioned or evident from the text or drawings. All of these different combinations constitute various alternative aspects of the invention.

9 Maintenance Types

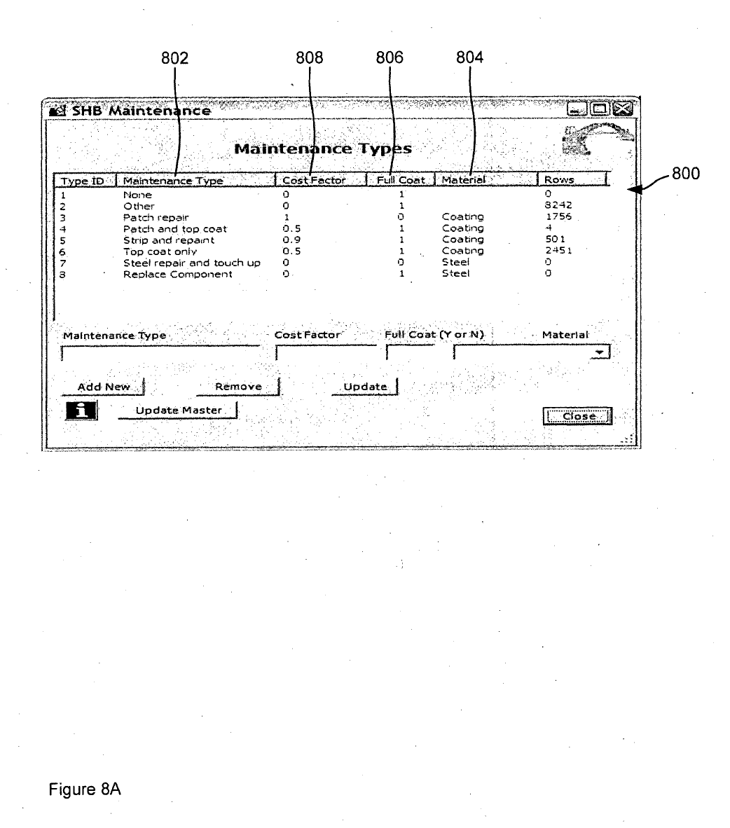

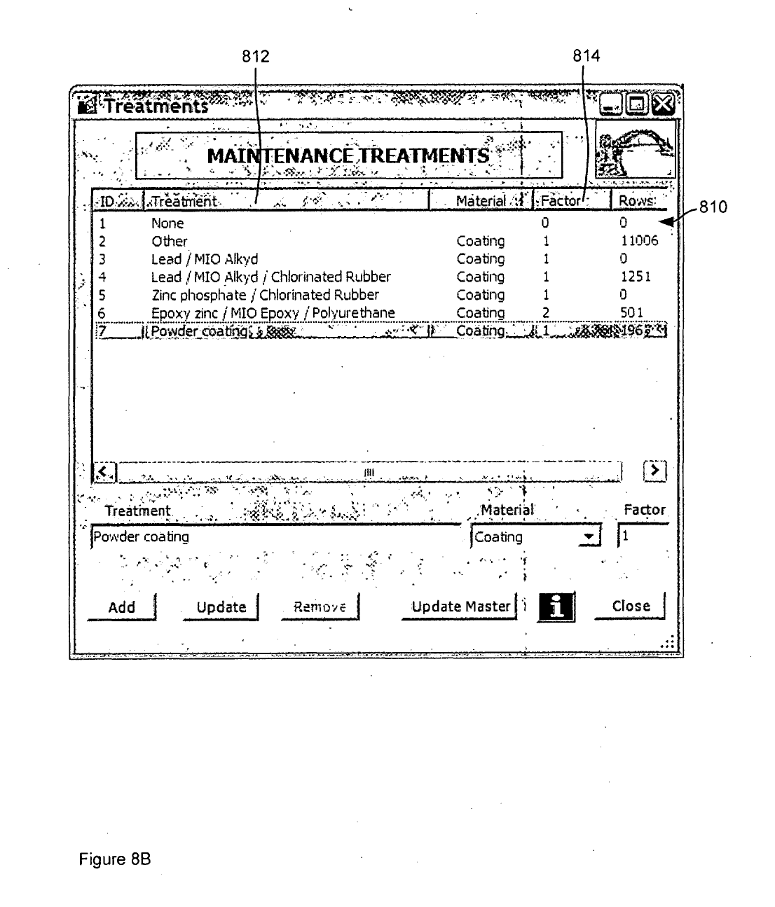

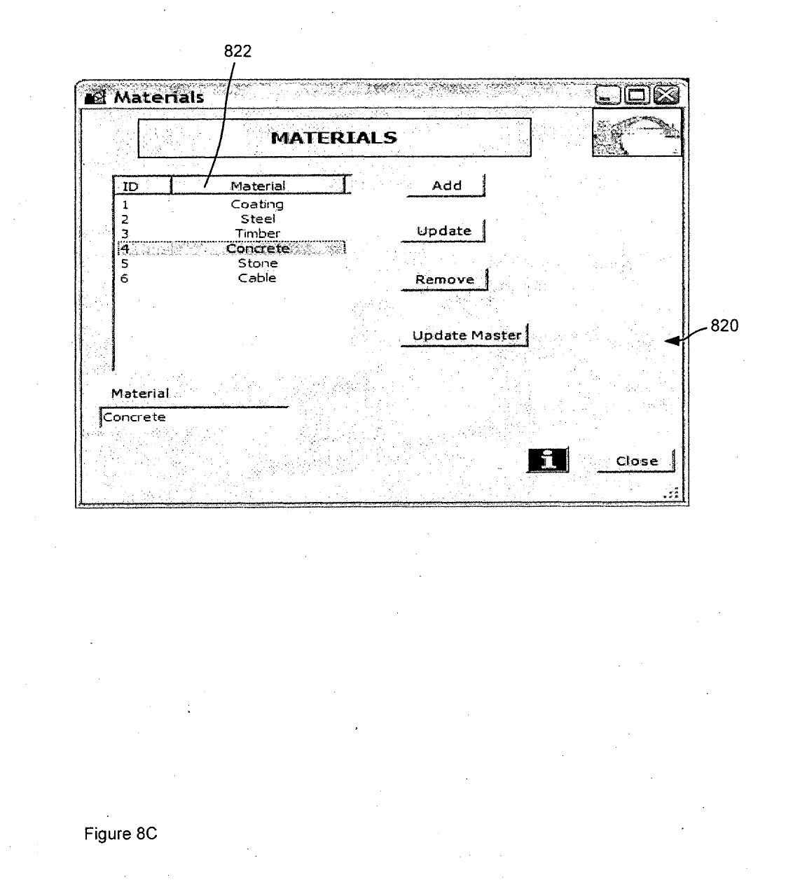

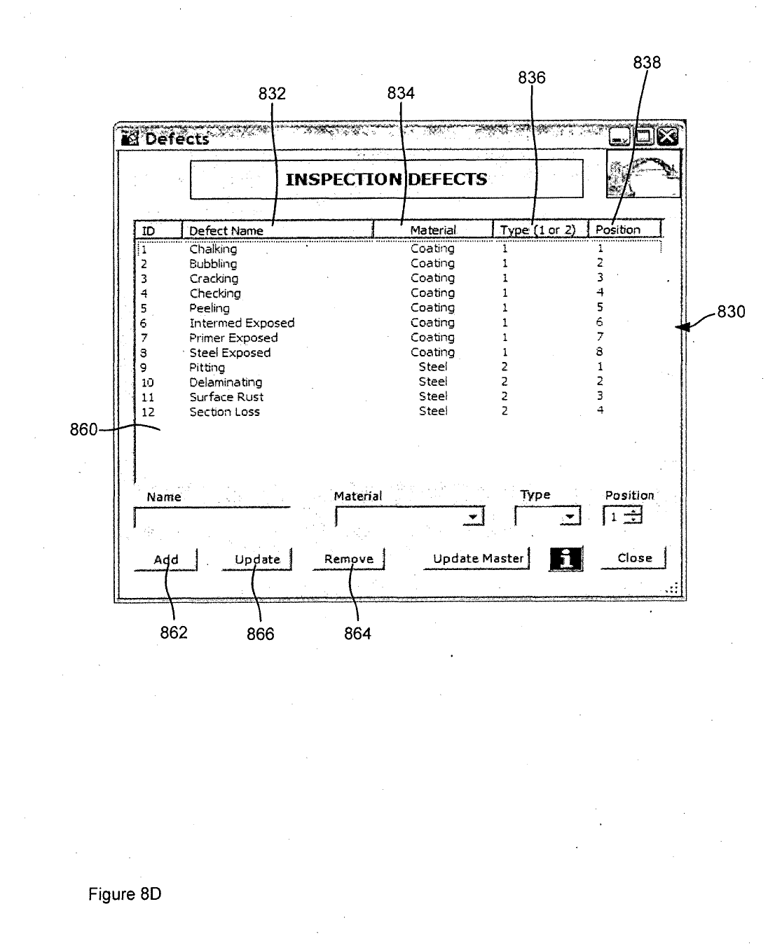

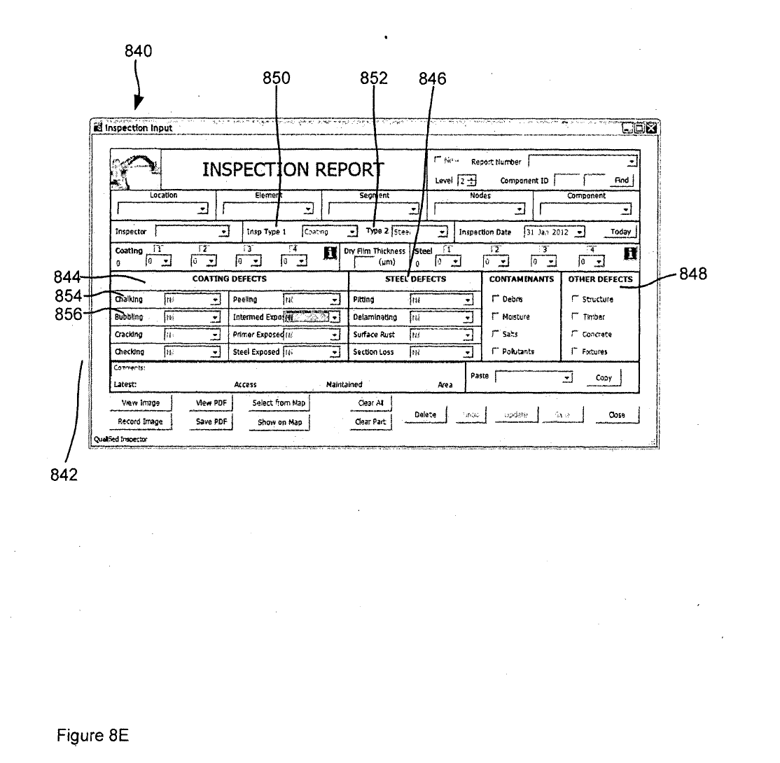

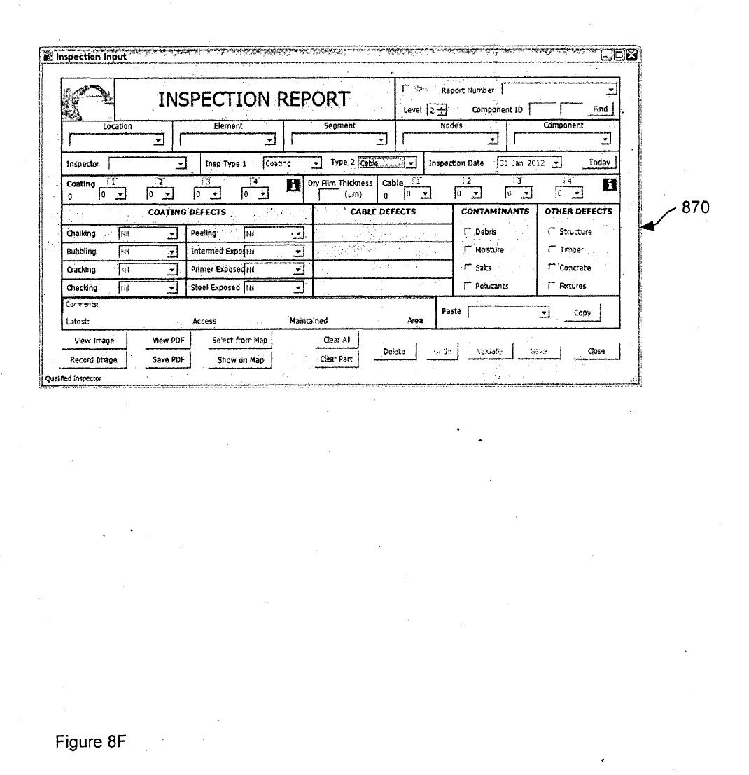

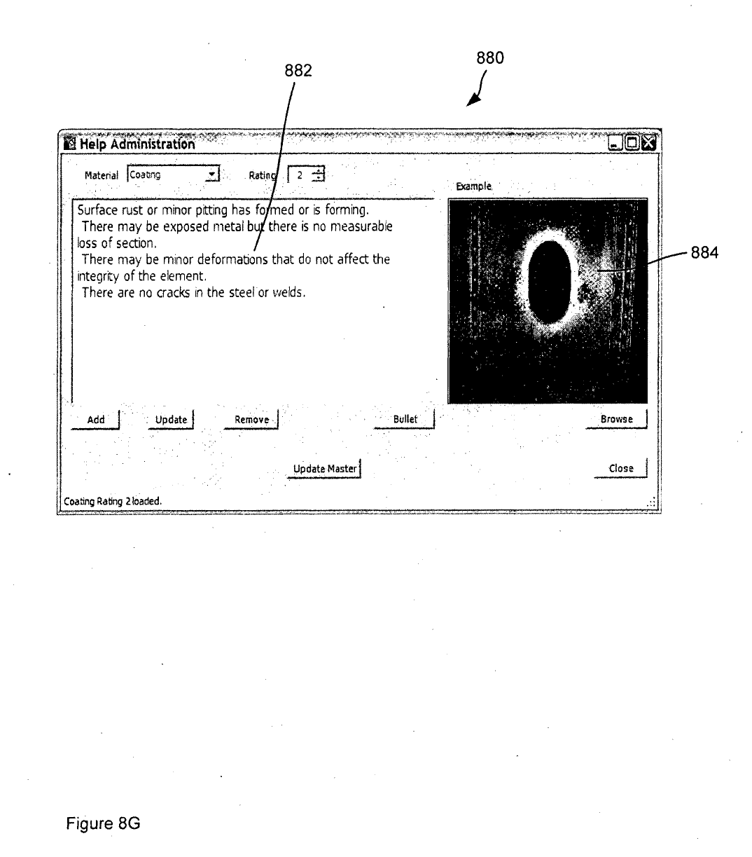

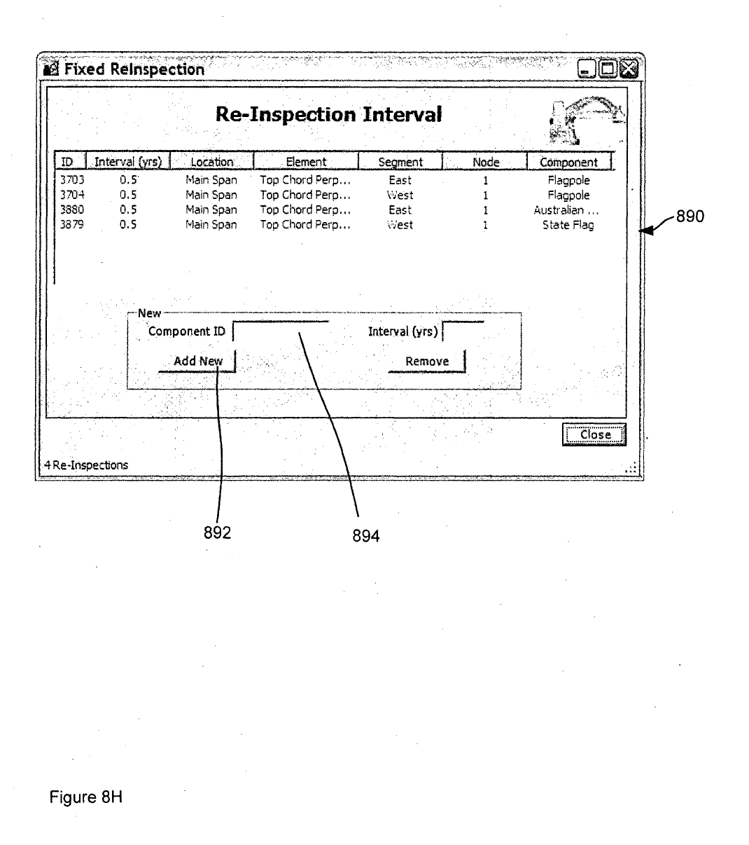

The List of Maintenance Types stored in the Database is kept up to date using form 800 as shown in FIG. 8A. Each maintenance type 802 has a material 804, a full coat indicator 806 (for coating types of maintenance only) and a cost factor 808. The cost factor 808 is a multiplier which is applied to the base cost of the component maintenance which more accurately reflects the true maintenance cost for this Type. For the Sydney Harbour Bridge the component cost is specified as a coating patch coat cost (this cost is stored in the BAASIS_DATA database table). The other maintenance types multiply this cost by the Cost Factor.

Treatment

Each maintenance type has a number of treatments which may be applied or carried out as part of the Maintenance Type as shown in the maintenance treatment dialog box 810 in FIG. 8B. For example, the Sydney Harbour Bridge the maintenance type “Top coat only” may be done with an epoxy paint treatment or a chlorinated rubber treatment.

Each treatment 812 has a factor 814 applied to it to further modify the cost stored in the DATA table. A more expensive treatment has a higher factor.

Materials

There can be any number of Materials—also referred to as Inspection Types which are available to the Inspectors and Maintenance users. Material will appear in inspection forms 820 and reports as shown in FIG. 8C.

### Inspection Defects

The types of defects will be required to be defined for each material. For example, steel can have a rust defect and concrete may have a spalling defect.

The defects 832 are specified in the inspection defects form 830 shown in FIG. 8D together with their location on the Inspection report 840. Each defect 832 has the material 834 which it affects, the type 836 and the position 838. The type 836 and position 838 refer to the location of the defect on the inspection report dialog box 840 as shown in FIG. 8E.

There are two defects sections 842 on the inspection report dialog box 840—one with eight possible defects 844 and the other with four possible defects 846. There is also an Other Defects section 848 but these are not changed by the user.

The defect type refers 836 to whether the defects belongs to the first defect section 844 for Type 1 850 or the second defect section 846 for Type 2 852. The positions 838 refer to the location of the defect within that area on the report 840. In the example in FIG. 8E chalking 854 is in Position 1, bubbling 856 in Position 2 etc.

When a defect is added 862 a new field 860 is appended to the Inspection Table 830 in the database. If a defect is removed 864 then this field and all the associated data is removed from the Table 830. Updating 866 a defect only changes the name on the form.

Note that it is not necessary to have defects for all material types. If a material type has no defects possible, then the area on the form is blank. For example, cable on the report 870 in FIG. 8F has no defects.

### Inspection Levels

Each inspection is given an inspection level depending upon the qualifications of the inspector to do that kind of inspection. The available levels are designated in the inspection levels form.

### Inspection Help

For each type of material (Inspection Type) a rating help description must be input. The software may be pre-loaded with coating and steel rating help but it is unlikely that these will apply to all structures. Therefore further rating help may be added.

For each material and rating level there is help text 882 and an example photo 884 as shown in help box 880 in FIG. 8G. The form allows you to edit the text of the help 882 and change the photo 884.

### Re-Inspection Intervals

Most of the coating materials on a bridge are reinspected on a basis set by the type of coating on the component and the current age. However, there are some components which are inspected regularly regardless of their current condition or maintenance. The two flag poles on the Sydney Harbour Bridge are examples of this.

The re-inspection intervals form 890 is used to set a component to have a regular inspection interval. To add a component 892 to this list the user must first get it's COMPONENT_ID value 894. This can be found by using the identify button on the Main Menu.

1. A computational system for managing maintenance of structure in the form of a bridge, a building or an iconic structure comprising a plurality of components with associated component features, the system comprising:
computer hardware, computer software and computer memory containing information for defining a model of the plurality of components and their associated component features;
the computer software including instructions to:
a) provide an interface via the computer hardware to:
i) receive and store inspection data including one or more ratings associated one or more of the component features;
ii) receive and store maintenance parameters associated with one or more of the component features, the maintenance parameters including a condition rating parameter; and
iii) display a map of the model;
b) use the stored inspection data to forecast a predicted condition rating;
generate dependent on the maintenance parameters, the predicted condition rating and/or the inspection data a maintenance plan of proposed maintenance for components to be maintained and output the maintenance plan; and
d) display on the map a visual representation of information selected from a group consisting of: the inspection data, the maintenance parameters and the maintenance plan.

2. The system of claim 1 wherein the maintenance parameters additionally comprise access method and/or cost parameters.

3. The system of claim 9 wherein the maintenance plan includes maintenance priorities determined by the criticality rating parameter.

4. (canceled)

5. (canceled)

6. (canceled)

7. (canceled)

8. The system of claim 1 wherein the one or more component feature characteristics are selected from the group consisting of: a paint condition rating, a prediction of paint life span, a rate of paint deterioration, a proportion of the paint condition rating in a condition state, and a proportion of the predicted paint condition rating in a condition state.

9. The system of claim 1 wherein the maintenance parameters include a component criticality rating parameter for a component criticality rating that is a weighting for at least one of the plurality of components comprised of one or a combination of ratings selected from the group consisting of: an environmental rating, an aesthetic rating and a structural rating.

10. (canceled)

11. (canceled)

12. (canceled)

13. (canceled)

14. (canceled)

15. A computer implemented method for generating a maintenance plan for a structure in the form of a bridge, a building or an iconic structure comprising components with associated component features, the method comprising:
storing information defining a model of the components and their associated component features and maintenance parameters associated with one or more of the component features, the maintenance parameters including a condition rating parameter;
receiving inspection data including ratings associated with the component features;
generating a maintenance plan for a plurality of said components, the maintenance plan generated responsive to the maintenance parameters and the entered inspection data; and
computing one or more component feature characteristics responsive to entered inspection data, wherein the one or more component feature characteristics are usable to forecast a predicted condition rating.

16. The method of claim 15 wherein the maintenance parameters further comprise an access method and/or cost parameters.

17. The method of claim 19 wherein the maintenance plan includes maintenance priorities determined by the plurality of component criticality rating parameters.

18. (canceled)

19. The method of claim 15 wherein the maintenance parameters include a plurality of component criticality rating parameters for component criticality ratings, each component criticality rating associated with one of said components and determined according to a weighting derived from one or a combination of ratings selected from the group consisting of: environmental rating, aesthetic rating and structural rating.

20. (canceled)

21. The method of claim 15 wherein the one or more component feature characteristics are selected from the group consisting of: a paint condition rating, a prediction of paint life span, a rate of paint deterioration, a proportion of the paint condition rating in a condition state, and a proportion of the predicted paint condition rating in a condition state.

22. (canceled)

23. (canceled)

24. (canceled)

25. (canceled)

26. The method of claim 15, further comprising colour coding the map by said maintenance parameters, the inspection data and/or the maintenance plan.

27. (canceled)

28. (canceled)

29. (canceled)

30. (canceled)

31. A computer implemented method for generating a maintenance plan for a structure, the method comprising:
generating a maintenance plan of proposed maintenance for at least one element of the structure, based on a paint or coating condition model, wherein the paint or coating condition model has a deterioration that progresses as a function of X̂4, where X is the proportion of the life span of paint or coating that has elapsed; and
outputting the maintenance plan.

32. A computer implemented method according to claim 31, wherein generating the maintenance plan is based on a plurality of the paint or coating condition models for the at least one element of the structure, wherein each model has a different coefficient and represents a different condition state of paint or coating;
wherein generating the maintenance plan based on the plurality of paint or coating condition models comprises at least one of:
receiving inspection data and based on the inspection data computing a proportion of the life span of paint or coating that has elapsed; and
receiving a proportion of the lifespan of paint or coating that has elapsed and computing a proportion of the paint or coating that has each condition model.

33. A computational system according to claim 1 wherein the structure is a steel structure.

34. (canceled)

35. (canceled)

36. (canceled)

37. (canceled)

38. (canceled)

39. (canceled)

40. The system of claim 1 wherein the software further includes instructions to calculate one or more component feature characteristics responsive to the stored inspection data, wherein the one or more component feature characteristics are usable to forecast the predicted condition rating.

41. The system of claim 8 wherein the rate of paint deterioration progresses as a function of X̂4 where X is a proportion of the paint life span that has elapsed.

42. The system of claim 1 wherein the computer software further includes instructions to colour code the map by the maintenance parameters, the inspection data, and/or the maintenance plan.

43. The system of claim 1 wherein inspection data is received per component, wherein each said component comprises one or more elements that require maintenance.

44. The method of claim 21 wherein the rate of paint deterioration progresses as a function of X̂4 where X is a proportion of the paint life span that has elapsed.
